(19) United States
(12) Patent Application Publication
(10) Pub. No.: US 2026/0361682 A1
(43) Pub. Date: Nov. 12, 2026

(54) FEDERATED IP ADDRESS MANAGEMENT

(71) Applicant: Infoblox Inc., Santa Clara, CA (US)

(72) Inventors: David W. Hankins, Milpitas, CA (US); Daniel Garcia, Austin, TX (US); Sastry Varanasi, Sunnyvale, CA (US)

(21) Appl. No.: 19/238,177

(22) Filed: Jun. 13, 2025

Related U.S. Application Data
(60) Provisional application No. 63/801,649, filed on May 7, 2025.

(51) Int. Cl. H04L 61/5007; H04L 41/04

(52) U.S. Cl. CPC H04L 61/5007; H04L 41/04

(57) ABSTRACT

The present application discloses a method, system, and computer system for performing an Internet Protocol Address Management (IPAM) action in the context of a federated IPAM system. The method includes: (i) generating a federated realm to manage one or more IPAM services, (ii) generating a plurality of objects associated with the federated realm, and (iii) applying a policy of the plurality of objects associated with the federated realm to the Internet Protocol (IP) address spaces of the one or more IPAM services.

### CROSS REFERENCE TO OTHER APPLICATIONS

This application claims priority to U.S. Provisional Patent Application No. 63/801,649 entitled FEDERATED IP ADDRESS MANAGEMENT filed May 7, 2025, which is incorporated herein by reference for all purposes.

### BACKGROUND OF THE INVENTION

Internet Protocol Address Management (IPAM) includes services to assign and resolve Internet Protocol (IP) addresses. For example, IPAM may include Domain Name Services (DNS) and Dynamic Host Configuration Protocol (DHCP) systems. Enterprises (e.g., companies, organizations, governments, etc.) often have complex systems to manage large numbers of IP addresses. Furthermore, such enterprises may be using a variety of IPAM services, such as BloxOne™ DNS DHCP and IP address management (B1DDI), Amazon Web Services™ (AWS) IPAM, Network Identity Operating System™ (NIOS), Google Cloud™ Internal Ranges, etc., to manage the IP addresses associated with the enterprise.

### BRIEF DESCRIPTION OF THE DRAWINGS

Various embodiments of the invention are disclosed in the following detailed description and the accompanying drawings.

FIG. 1 is a block diagram of a federated IPAM system in accordance with some embodiments.

FIG. 2 is a block diagram of a system for interacting with IPAMs using a federated IPAM system in accordance with some embodiments.

FIG. 3 is a block diagram of an IPAM system in accordance with some embodiments.

FIG. 4 is a block diagram of an IPAM federation service architecture in accordance with some embodiments.

FIG. 5A is a block diagram of a federated IPAM system which includes integration with various components in accordance with some embodiments.

FIG. 5B is a block diagram of a federated IPAM system which includes integration with different cloud vendors in accordance with some embodiments.

FIG. 6 is a block diagram of a federated IPAM system with an integrated on-prem IPAM system in accordance with some embodiments.

FIG. 7 is a flow diagram of a process for implementing a federated IPAM system in accordance with some embodiments.

FIG. 8 is a flow diagram of a process for allocating an IP address using a federated IPAM system in accordance with some embodiments.

FIG. 9 is a flow diagram of a process for federating an IP address in a federated realm in accordance with some embodiments.

FIG. 10 is a flow diagram of a process for performing an IPAM action in the context of a federated IPAM system in accordance with some embodiments.

FIG. 11 is a sequence diagram 1100 for allocating an IP address using a federated IPAM system in accordance with some embodiments.

FIG. 12 is a flow diagram of a process for integrating a third-party IPAM service into a federated IPAM system.

FIG. 13 is a flow diagram for a process for mirroring and/or inferring federated realms from one or more CSP IPAM systems.

FIG. 14 is a block diagram of a configuration of a federated IPAM system in accordance with some embodiments.

FIG. 15 is a sequence diagram for creating a subnet in a federated IPAM system in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Internet Protocol Address Management (IPAM) includes services to assign and resolve IP addresses. For example, IPAM may include Domain Name Services (DNS) and Dynamic Host Configuration Protocol (DHCP) systems. Enterprises (e.g., companies, organizations, governments, etc.) often have complex systems to manage large numbers of IP addresses. Furthermore, such enterprises may be using a variety of IPAM services, such as BloxOne™ DNS DHCP and IP address management (B1DDI), Amazon Web Services™ (AWS) IPAM, Network Identity Operating System™ (NIOS), Google Cloud™ Internal Ranges, etc. to manage the IP addresses associated with the enterprise.

Specifically, enterprises, such as companies, organizations, governments, etc., typically manage a large number of Internet Protocol (IP) addresses. Enterprises often use a large number of IP addresses to support their network infrastructure, accommodate a large volume of devices (e.g., computers, servers, printers, IoT devices, network devices, etc.), and ensure reliable communication within and outside the enterprise. A large pool of IP addresses allows for proper network segmentation, scalability, security, and easier management of traffic. Additionally, such an IP address management scheme generally helps with redundancy, load balancing, and the need for specific addresses for different applications, services, or regions.

In order to maintain and manage large numbers of IP addresses, enterprises typically use one or more Internet Protocol Address Management (IPAM) systems (e.g., also generally referred to herein as IPAMs). Generally, IPAM systems are tools for efficiently managing, tracking, and organizing the allocation of IP addresses within a network. They help automate the process of assigning IP addresses to hosts, ensuring that addresses are efficiently utilized and preventing issues such as conflicts or misallocations of the IP addresses. Hosts may be any device that can have an IP address, such as servers, computers, tablets, phones, printers, etc. IPAMs integrate with other network services, including, for example, DHCP (Dynamic Host Configuration Protocol) services and DNS (Domain Name System) services, to offer centralized control, providing visibility into address pools, their usage, and availability. They allow network administrators to define and manage IP address subnets, ensuring proper segmentation and optimized network traffic. Additionally, IPAMs can generally track both dynamic and static IP assignments, monitor network health in real-time, and generate alerts or reports for address shortages, conflicts, or potential IP address related issues.

Many enterprises use more than a single IPAM to manage all the IP addresses associated with the enterprise. Furthermore, these IPAMs may use different services. Some IPAMs are hosted using cloud service providers (CSPs), such as BloxOne™ DNS DHCP and IP address management (B1DDI) which are commercially available from Infoblox Inc. headquartered in Santa Clara, CA, Amazon Web Services™ (AWS) IPAM), Google Cloud™ Internal Ranges, etc. Enterprises may also have IPAM services that are on premises (on-prem), for example, Network Identity Operating System™ (NIOS) which is commercially available from Infoblox Inc. headquartered in Santa Clara, CA.

Enterprises may have multiple IPAM services using multiple platforms and providers for a variety of reasons. For example, when a company acquires another company, instead of integrating the entire IPAM of the second company, the first company may manage both IPAMs. Another example is when companies maintain two separate grids of IP addresses.

Using multiple IPAMs for the same enterprise can often lead to a disjointed and opaque IP address allocation plan and difficulties in administrating the IPAMs. One problem is the unmanageable overlap of IP addresses associated with the same enterprise, e.g., conflicts in address spaces. Current solutions to remedy conflicts in address spaces, especially when an enterprise maintains one or more IPAMs, are difficult to implement and are error prone. For example, one solution includes manually keeping track of which IP addresses are allocated on each IPAM service. This problem may be further complicated in the case of acquisitions. For example, a company may acquire a second company which has a completely different way of managing its one or more IPAM systems.

In some instances, enterprises intend to implement the same IP address for two different hosts. This may be applicable when the same IP address is used in two different namespaces. However, implementing this feature is extremely difficult using current systems due to the disjunction of one or more IPAM services. Furthermore, when an enterprise acquires another IPAM, there is a high possibility that the second IPAM comprises an IP address that overlaps with one in an existing IPAM.

The overlapping/reuse of IP addresses is increasing. For example, one private service may maintain an address space that has overlap with another private service. This may complicate communication between the two private services. This problem is further exacerbated because unique IPv4 addresses have been exhausted, and some cloud environments may have poor adoption of IPv6. Furthermore, the industry is moving towards cloud and multi-cloud environments.

Given the complexity of an enterprise's IPAM system, it is typically prohibitively costly to introduce improvements or make any changes to existing systems. For example, it can be very difficult to introduce more IP addresses, increase the size of a subnet, adjust/add security policies associated with IP addresses, and/or make any other changes to an enterprise's IP addresses.

As such, integrating IPAMs from a variety of providers, sources, and/or services is technically challenging and error prone.

Accordingly, the techniques disclosed herein describe a federated IPAM solution that simplifies management of multiple IPAMs by an enterprise.

In some embodiments, a system, a process, and/or a computer program product for a federated IPAM solution includes generating a federated realm to manage one or more IPAM services, generating a plurality of objects (e.g., federation objects) associated with the federated realm, and applying the policies of the objects associated with the federated realm to the IP address spaces of the one or more IPAM services.

In some embodiments, a system, a process, and/or a computer program product for a federated IPAM solution includes receiving an allocation request to allocate an IP address at an IPAM (e.g., an IPAM system), calculating an allocation policy associated with the IP address at a policy service, sending a federate request to the IPAM associated with the request to allocate the IP address, and federating the IP address in a federated realm associated with the IPAM.

In some embodiments, a system, a process, and/or a computer program product for a federated IPAM solution includes receiving a request to perform an IPAM action at a data modeling service associated with a federated IPAM system, determining whether the IPAM action is permissible given a current state of the federated IPAM system, and in response to a determination that the IPAM action is permissible, coordinating one or more IPAMs to execute the IPAM action; and updating the current state of the federated IPAM system to reflect the IPAM action.

The disclosed techniques for a federated IPAM solution alleviate and/or solve many issues with current IPAM solutions. As an example, the disclosed techniques for a federated IPAM solution manage a plurality of IPAMs automatically using a single root authority. Problems associated with overlapping IP addresses on one or more IPAM services are thereby alleviated by effectively and efficiently managing a plurality of IP addresses and performing various IPAM related tasks, such as adding IP addresses, changing security policies, solving conflicts between existing IP addresses, etc., such as will be further described below.

As another example, the disclosed techniques for a federated IPAM solution can be employed by an enterprise that already uses one or more different IPAM services. Thus, an enterprise can use the disclosed techniques to effectively and efficiently manage a plurality of existing IPAM services. Furthermore, an enterprise can efficiently introduce one or more new IPAM systems to a federated IPAM system, for example, in the case of a merger and/or acquisition of a company with other IPAM systems.

These and other examples and embodiments for a federated IPAM solution will now be further described below.

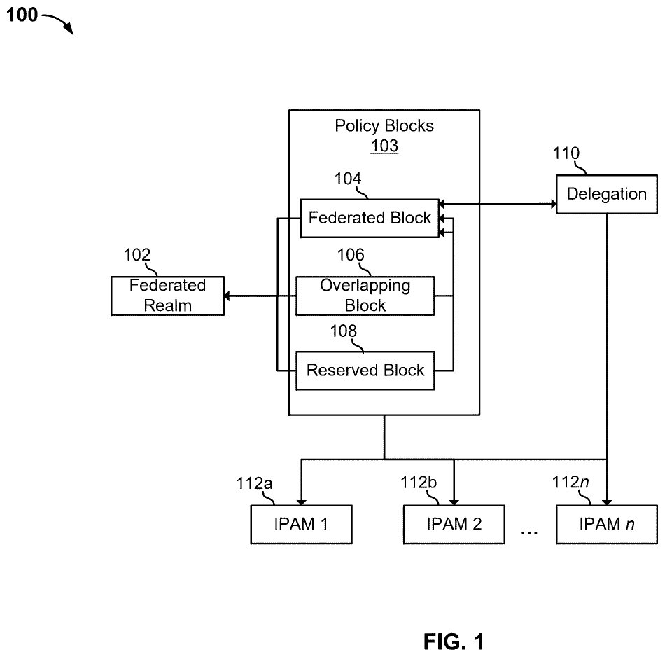

FIG. 1 is a block diagram of a federated IPAM system in accordance with some embodiments. Federated realm 102 is associated with the policy blocks 103. Policy blocks 103 comprises federated block 104, overlapping block 106, and reserved block 108. Policy blocks 103 represent blocks of IP addresses with various policies that are associated with federated realm 102 Policy blocks 103 may coordinate policies with IPAMs 112a, 112b, . . . , 112n.

IPAMs 112 1:n each manage one or more sets of IP addresses. A set of IP addresses may be a block, a subnet, a range, and/or individual IP addresses. In some embodiments, delegation 110 manages the delegation between federated block 104 and an IPAM 112n. The allocation of each of the sets of IP addresses is managed and executed by federated IPAM system 100. Using this system, an enterprise may efficiently allocate and manage a plurality of IP addresses over one or more IPAM services.

Federated IPAM system 100 can be implemented on one or more devices and provided to an enterprise by a networking company. Examples of devices include servers, computers, desktops, phones, tablets, etc. Federated IPAM system 100 can be used by an enterprise to allocate an IP address. An enterprise can allocate an IP address for a number of reasons, such as setting up new devices on a network, providing new services, hosting a website, hosting a database, hosting an internal application, etc.

Federated realm 102 can be implemented on one or more devices (e.g., one or more servers). It can be implemented on the cloud (e.g., by a cloud service provider (CSP)) or on an enterprise's premises. In some embodiments, federated realm 102 includes a data store (e.g., one or more databases) comprising information necessary for implementing a federated realm (e.g., IP address routing data, ranges, security information, . . . , etc.) and a processor that facilitates actions associated with federated realm 102. Examples of actions include facilitating additions of IPAMs, additions of IPAM address blocks, additions of policy blocks 103, delegation between policy blocks 103 and IPAM address blocks, etc.

In this example implementation, federated realm 102 includes a set of all possible IP addresses in any IP protocol version (e.g., IPv4 and/or IPv6), regardless of the address usage. This ensures that any IP addresses on any IPAM 112n can be reached using a unique IP address. Federated realm 102 can include one or more database records. A database record may represent an IP address space within a routing context. To further illustrate, federated realm 102 may be represented by one or more records indicating it is associated with IPv4 Range: 192.0.2.1-192.0.2.254 and/or IPv6Range:: 2001: db8:3333:4444:5555:6666:1.2.3.4, :: 11.22.33.44. In some embodiments, federated realm 102 is associated with an IPv4 range and/or an IPv6 range.

In some embodiments, federated realm 102 is implemented such that any IP address within a given federated realm 102 can directly reach any other IP of the same protocol within the same federated realm 102 with no other needs than routing.

In some embodiments, federated realm 102 retains root authority over all address blocks associated with the federated realm. As such, child IPAM services (e.g., IPAM 112n) delegate with federated realm 102 before allocating an IP address within federated realm 102's IP address space. Delegation with child IPAM services can be facilitated by delegation 110. IP addresses that are delegated between federated realm 102 and IPAM 112n using delegation 110 may be associated with federated block 104. This reduces complexity in allocating new IP addresses when the IP address space of an enterprise is managed by multiple IPAM services.

Federated realm 102 allows an enterprise to use a common shared address space without errors caused by collisions, where IP addresses are spread across different IP spaces and/or managed in different IPAMs 112a, 112b, . . . , 112n. Collisions may occur when two or more blocks of IP addresses overlap in part or fully (e.g., when an IP address of one block is also used in one or more other blocks). Another example of a collision is when two or more network destinations are associated with the same IP address.

In some embodiments, an enterprise may use two or more federated realms to allow for collisions. In some embodiments, in a single federated realm 102, collisions of prefixes are prohibited. However, two colliding IP addresses may be facilitated by two or more federated realms. Thus, IPAM 112a and IPAM 112b may be managing a source associated with IP address 10.0.1.0. This collision can be rectified by using two federated realms, where each federated realm is only able to reach 10.0.1.0 of IPAM 112a or IPAM 112b.

In some embodiments, collisions may be allowed in a single federated realm 102 through the use of overlapping block 106. Further discussion of overlapping block 106 is provided below.

Policy blocks 103 comprise one or more blocks of IP addresses, where each block is associated with a given policy. Policy blocks 103 includes federated block 104, overlapping block 106, and reserved block 108. Policy blocks 103 is a group of IP blocks that are associated with federated realm 102.

Each of policy blocks 103 is associated with a policy in federated realm 102. The creation of a policy block asserts that IPAMs 112 1:n should apply the given policy to the block of IP addresses. For example, the creation of federated block 104 is an assertion of a policy on IPAMs 112 1:n that indicates IPAMs 112 1:n can use the IP addresses to allocate their unique space from. In some embodiments, unique spaces can be allocated by requesting a delegation (e.g., delegation 110) for the space.

In some embodiments, each policy of policy blocks 103 is coordinated with a policy component of an IPAM (e.g., through an Open Policy Agent (OPA) component). For example, there may be a policy decision in the federated realm space, and that policy is sent to the OPA component of one or more of IPAMs 112 1:n.

In this example, there is one of each policy block, however, it should be understood policy blocks 103 may include one or more of each type of block. Furthermore, a single enterprise may maintain one or more federated realms.

In some embodiments, policy blocks 103 are nested in a hierarchy. For example, one or more reserved blocks (e.g., reserved block 108) can be under one or more federated blocks (e.g., federated block 104) that changes the policy for a sub-space (a part of the federated block becomes reserved).

Federation objects including policy blocks 103, federation realm 102, and delegation 110 may be organized using a hierarchical structure. For example, a federated realm 102 may be the highest node of an HTree, BTree, or other tree data structure. The other federation objects may be nodes on the tree.

Federated block 104 represents a set of contiguous IP addresses in federated realm 102. In some embodiments, each IP address is associated with a classless inter-domain routing (CIDR) notation that identifies federated block 104. Federated block 104 comprises IP addresses for which federated realm 102 is authoritative for (e.g., maintains the root authority over).

Federated block 104 includes an IP address space for which it is guaranteed there are no overlaps between any other address block (e.g., overlapping block 106, reserved block 108, and/or another federated block) on the same level. For example, if IP address space 10.1.1.0/24 is within federated block 104, then none of the IP addresses in the space will be present in policy blocks 103.

In some embodiments, federated block 104 is used to identify the IPAM that is responsible for managing the address block. For example, federated block 104 can maintain a plurality of IP addresses associated with an address block within IPAM 112a.

In some embodiments, federated block 104 is used to reserve address space for unique allocations across network boundaries sharing edges with multiple IPAMs.

In some embodiments, federated block 104 is used to denote the available network space on IPAMs 112a, 112b, . . . , 112n. This available network space can be used to allocate IP addresses associated with federated realm 102. For example, federated block 104 can store information indicating that a certain IP range is unused on one or more of the IPAMs 112 1:n. Thus, when new resources are added, IP addresses in this unused range may be used.

In some embodiments, federated block 104 has children that are other federated blocks and/or a parent which is another federated block. When federated block 104 has a parent federated block, the parent federated block fully includes all IP addresses of federated block 104.

In this example, federated block 104 has delegation 110 as a child. In some embodiments, delegation 110 is fully contained in federation block 104 and is used to indicate that the authority for a subset or the whole of the IP address space of federated block 104 is assigned to an IPAM (e.g., IPAM 112n). This means that use of the IP addresses within federated block 104 and delegation 110 must be in accordance with the policies of IPAM 112n as well as the policies of federated block 104.

Overlapping block 106 represents an IP address range for which authority is expressly abandoned by all IPAMs 112 1:n. IPAM 112n may allocate from this space locally without federal negotiation within the scope of federated realm 102. In some embodiments, each IP address is associated with a CIDR notation that identifies overlapping block 106. Overlapping block 106 may be used to inform a dynamic policy such that IPAMs 112 1:n can use IP addresses within this range to perform local operations.

In some embodiments, IP addresses in overlapping block 106 are only used locally, due to the overlapping nature. For example, all users participating in federated realm 102 can use IP addresses in overlapping block 106 to host a private Kubernetes™ instance.

The policy of overlapping block 106 may be applied by permitting requests from IPAMs 112 1:n to allocate the IP address space of overlapping block 106. The overlapping block 106 policy allows two or more IPAMs 112 1:n to allocate the same IP address space.

Reserved block 108 represents an address space for which usage by IPAMs 112 1:n is restricted. In this example, federated IPAM system 100 claims authority over the IP addresses in reserved block 108. In some embodiments, IP addresses in reserved block 108 are restricted from allocation by IPAMS 112 1:n.

The policy of reserved block 108 may be applied by denying any request by any IPAM 112 1:n for allocation of an IP address space of reserved block 108. For example, suppose IP address space 10.1.1.0/24 is within reserved block 108. If IPAM 112a attempts to allocate this IP address space, it will send a request to policy blocks 103 asking to allocate the space, which will deny the request to allocate IP address space 10.1.1.0/24. In some embodiments, the IP addresses in reserved block 108 are used only by federated realm 102.

Reserved block 108 may be created for a variety of purposes. For example, a reserved block 108 may be created to artificially reduce the size of a federated block 104. A created reserved block 108 may be configured to deny requests for an IP space until a need arises in the future. Other examples include denying certain requests to allocate one or more IP addresses from an IPAM 112n and dealing with IP address exhaustion.

In some embodiments, each IP address in reserved block 108 is associated with a classless inter-domain routing (CIDR) notation that identifies reserved block 108.

IP addresses in reserved block 108 may overlap with other blocks associated within federated realm 102 (e.g., federated block 104, overlapping block 106, etc.).

Delegation 110 is used to indicate the authority of an IP address space in federated realm 102. In embodiments, delegation 110 utilizes a CIDR notation prefix that represents an IP address range that has been delegated to a cooperating IPAM service.

To illustrate, federated block 104 may be mapped with an IP address block within IPAM 112n. Delegation 110 provides a policy that indicates that federated block 104 is managed by IPAM 112n. In some embodiments, IPAM 112n locally manages an IP address block that has been delegated to it by delegation 110. For example, IPAM 112n can create a subnet from a delegated block.

In some embodiments, federated realm 102 configures IPAM 112n through delegation 110. For example, federated realm 102 can require a large subnet in IPAM 112a for use by federated block 104. As described below, Application Program Interfaces (APIs) can be used to perform such an operation.

Delegation 110 can map a federated block (e.g., federated block 104) to any address space in IPAMs 112 1:n.

In the example shown, delegation 110 is a child of federated block 104. In some embodiments, delegation 110 can map a different policy block (e.g., overlapping block 106) to any address space of IPAM 112 1:n.

In some embodiments, delegation 110 maps one federated block 104 to one IPAM 112n. In some embodiments, more than one federated block 104 can be mapped to one IPAM 112n.

In some embodiments, a particular policy block is mapped to a particular IP address block and/or subnet that is within IPAM 112n. For example, IPAM 112n can comprise multiple IP address blocks where each IP address block is mapped to a different federated block through a different delegation.

Delegation 110 may be associated with one or more federated blocks by a child-parent relationship. In some embodiments, delegation 110 is associated with R (an integer) federated realms and implicitly associated with <=R federated blocks. In the scope of a single federated realm, delegation 110 may have a parent that is a federated block.

In some embodiments, delegation 110 has no parent within the scope of a federated realm. In these embodiments, delegation 110 is defined within the scope of multiple federated realms.

In some embodiments, delegation 110 is associated with a single IPAM (e.g., IPAM 112n).

Delegation 110 may organize the mapping of IP address blocks between one or more a federated block 104 and IPAM blocks in any logical manner.

In some embodiments, delegation 110 is associated with a single IPAM 112n.

IPAM 112n comprises any IPAM service. The IPAM service may be hosted on the cloud or on the premises (on-prem) of an enterprise associated with federated IPAM system 100. Examples of IPAM services include BloxOne™ DNS DHCP and IP address management (B1DDI), Amazon Web Services™ (AWS) IPAM, Network Identity Operating System™ (NIOS), Google Cloud™ Internal Ranges, . . . etc.

In some embodiments, IPAM 112n organizes IP address blocks. The blocks may be further divided into smaller subnets. As such, this allows for more granular control over IP address allocation. Each subnet may have an address range, a specific segment of IP addresses, which can be assigned to various devices or services. Within these ranges, individual IP addresses are allocated to hosts on a network. Hosts may be any device that can have an IP address such as servers, computers, tablets, phones, printers, etc. IPAM 112n may independently track and manage these IP addresses to avoid conflicts, optimize address usage, and improve network efficiency. Through this management, it ensures that addresses are distributed efficiently and that devices can communicate without issues. Federated IPAM system 100 manages IP addresses across IPAM 112 1:n.

In an example implementation, IPAM 112n can include an IPAM Application Program Interface (API) that allows an enterprise using federated IPAM system 100 to interact with the IPAM services programmatically. An IPAM API may be called to execute various actions within an IPAM. Examples of IPAM API calls include: “get all subnets,” “create new subnet,” “allocate a free IP address,” “reserve an IP address,” “get details of a specific IP address,” “search for available IP ranges,” “update subnet details,” “delete a subnet,” “discover new network devices,” “check for IP address conflicts,” . . . etc.

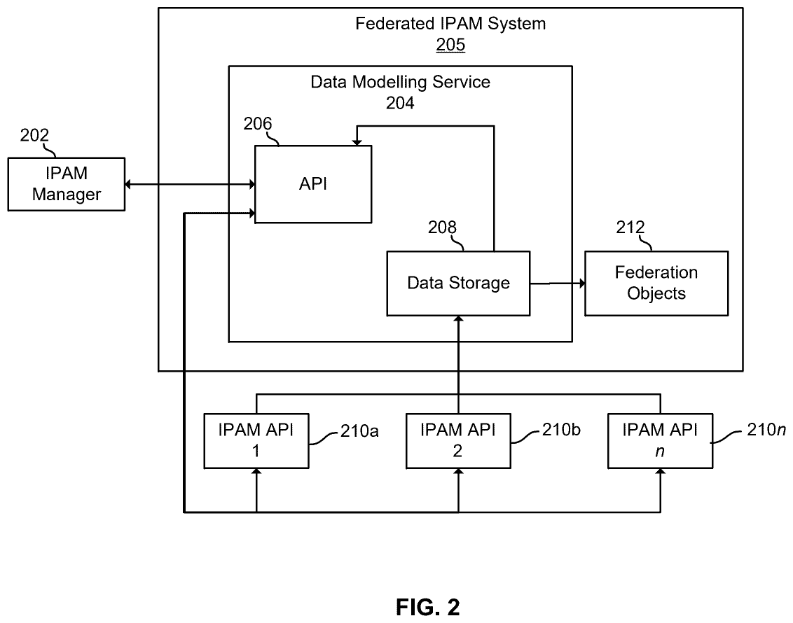

FIG. 2 is a block diagram of a system for managing IPAMs using a data modeling service in accordance with some embodiments. Federated IPAM system 205 may use data modeling service 204 to implement a federation service which includes the IPAMs associated with IPAM APIs 210a:n.

IPAM manager 202 may be any device responsible for managing IPAM services on behalf of an enterprise. In some embodiments, IPAM manager 202 is a device used by a user (e.g., an Information Technology (IT) employee) responsible for managing IPAMs. In some embodiments, IPAM manager 202 comprises software that automates the management of IPAMs.

Federated IPAM system 205 includes federation objects 212. Federation objects 212 includes one or more policy blocks. Federation objects 212 may include one or more delegations. Federation objects 212 comprises the state of federated IPAM system 205. The state includes how federation objects 212 are associated with the IPAMs of IPAM APIs 210a:n.

Federated IPAM system 205 also comprises data modeling service 204. Data modeling service 204 has access to federation objects 212 and may use the information of federation objects 212 to determine if an IPAM action is possible.

Data modeling service 204 is configured to model the state of IPAMs that are associated with federated IPAM system 205. Data modeling service 204 stores the state of the IPAMs in data storage 208. The state of the IPAMs includes how IP address spaces are allocated within the IPAM (e.g., whether or not a subnet is free for use).

The state may be fetched using API 206 at the request of IPAM manager 202. API 206 may send one or more requests for IPAM state to IPAM APIs 210a:n. The data representing the states of the IPAMs is sent and stored in data storage 208.

With an initial state of the IPAMs stored in data storage 208, federated IPAM system 205 may use the known state to apply the policies dictated in federation objects 212 to the IPAMs. Furthermore, requests for IPAM actions may be sent by IPAM manager 202 to data modeling service 204. These actions may involve federated IPAM system 205 and the IPAMs.

In some embodiments, federation IPAM system 205 maintains a single root authority over one or more IPAMs without removing authority from the external IPAM services. For example, IPAM manager 202 may request API 206 to make a particular IPAM's subnet A larger. Data modeling service 204 may forward this request to IPAM API 210n (the API associated with the particular IPAM) and await a response. If the IPAM responds that subnet A may be larger, subnet A within the IPAM is made larger and this update is represented in data storage 208. In some embodiments, data storage 208 receives the updated state of the IPAM by explicitly requesting an update from an IPAM API 210n. In some embodiments, IPAM API 210n automatically sends the update to data storage 208.

The update may be forwarded by data modeling service 204 such that it is properly represented within federation objects 212. The update may then by represented within federation objects 212. For example, a delegation previously assigned to subnet A may now be assigned to a larger subnet.

If the IPAM responds that the operation is impossible, the IPAM action may be denied.

Using data modeling service 204, federated IPAM system 205 can ensure that conflicts between IPAMs do not occur.

API 206 provides IPAM manager 202 a way to initialize, manage, and/or configure federated IPAM system 205. Furthermore, API 206 allows IPAM manager 202 to coordinate one or more IPAM services. This may be done by providing API calls which can interface with IPAM APIs 210 1:n.

API 206 also allows IPAM manager 202 to interface with various instances (e.g., federated realms, federated blocks, overlapping blocks, reserved blocks, and/or delegations) within federated IPAM system 205 using API endpoints that support API operations such as GET, PATCH, POST, DELETE, . . . , etc. Example API endpoints include federated realm, federated block, delegation, overlapping block, reserved block, . . . , etc.

Each of these API endpoints has one or more associated attributes. For example, the delegation API endpoint may have the following associated attributes: id, federated_realms, parents, address, cidr, protocol, delegated_to, delegated_space_is, name, comment, and/or tags. To further illustrate, the “delegated_to” attribute may be called to fetch authoritative information from an associated IPAM service when authoritative information on the delegation is fetched.

Using API 206, IPAM manager 202 can quickly implement federated IPAM system 205. For example, IPAM manager 202 use a series of POST operations on API 206 to initiate a set of federation objects 212.

Now, with federation objects 212 initiated, IPAM manager 202 may use API 206 as a middleman to integrate one or more IPAMs with federated IPAM system 205. This may be done by reading the resources of each IPAM and allocating these resources in relation to federation objects 212.

This system facilitates the execution of IPAM actions in the scope of federated IPAM system 205. For example, API 206 may send a request to IPAM API 210a to assign subnet A to delegation B. Suppose this request is accepted by the IPAM. Now, when any mutation is attempted on subnet A (even if it is done through the IPAM), IPAM API 210a will check to see if the mutation is possible given the state of federated IPAM system 205. It may do this by sending an API request (e.g., a federate request) to API 206. Federated IPAM system 205 now determines whether the IPAM action is possible by analyzing federation objects 212 (which includes delegation B) and data storage 208. If the request is possible, then subnet A is made larger in data storage A and delegation B now reflects that subnet A is larger.

Data storage 208 comprises representations of data stored on the IPAMs associated with IPAM APIs 210a:n. Information may include IP address allocation, IP address mappings, definitions of IP address blocks, definitions of IP address subnets, etc. Data storage 208 may store mappings between IPAMs and federation objects 212 (e.g., information indicating that a block belongs to a delegation).

IPAM APIs 210 1:n are the API's of one or more IPAMs. Both CSP and on-prem IPAM services provide APIs to interact with the associated IPAM system. For example, AWS™ IPAM provides the Amazon™ VPC IPAM API. This API facilitates a variety of actions such as AllocateIpamPoolCidr, CreateIpam, CreateIpamPool, CreateIpamScope, CreateIpamResourceDiscovery, CreatePublicIpv4Pool, DeleteIpam, DeleteIpamPool, DeleteIpamResourceDiscovery, DeletePublicIpv4Pool, DeprovisionIpamPoolCidr, DeprovisionPublicIpv4PoolCidr, DescribeIpams, DescribeIpamResourceDiscoveries, DescribeIpamResourceDiscoveryAssociations, DescribePublicIpv4Pools, EnableIpamOrganizationAdminAccount, GetIpamAddressHistory, GetIpamDiscoveredAccounts, GetIpamDiscoveredPublicAddresses, GetIpamDiscoveredResourceCidrs, GetIpamPoolAllocations, GetIpamPoolCidrs, GetIpamResourceCidrs, ModifyIpam, ModifyIpamPool, ModifyIpamResourceCidr, ModifyIpamResourceDiscovery, ModifyIpamScope, MoveByoipCidrToIp, . . . etc.

Data modeling service 204 provides visibility into one or more IPAMs using the connection between API 206 and IPAM APIs 210 1:n. The visibility may be used to determine the usability of IP address space and whether subnets need to be renumbered. Furthermore, the visibility allows for dynamic addressing, policy enforcement, and delegation.

Data modeling service 204 can be configured to store the API calls associated with IPAM APIs 210 1:n and understand how to use each of the APIs in order to execute federated IPAM related actions. For example, data modeling service 204 can be configured to integrate with an AWS™ provided IPAM API.

Data modeling service 204 ensures that policies associated with federated system 205 are applied when actions are performed. This can be done because data modeling service 204 maintains a representation of the IPAMs it is associated with. This eliminates issues such as IP address misallocations and conflicts.

IPAM actions may be executed in the context of federated IPAM system 205. An IPAM action may be initiated by a request from IPAM manager 202. An IPAM action may be any action relating to the use of a set of IP addresses (e.g., a block, a subnet, a range, and/or an individual IP address) associated with one or more IPAMs. IPAM actions may involve visibility, mutability, compliance, and/or reporting. Examples of IPAM actions include creating a delegation (e.g., between a policy block and an IPAM), allocating one or more IP addresses, using an IP address, disposing of an IP address, viewing the properties of one or more IPAMs, etc. For example, an action can be a request to create a subnet and delegate the subnet between an IPAM and the federated IPAM system. Whether or not the IPAM action is possible given the state of federated IPAM system 205 is determined after the action is initiated. In response to a determination that the IPAM action is possible, API 206 coordinates with IPAM APIs 210 1:n to execute the action. After the action is executed, the state of the federated IPAM system may be updated. This may comprise updating data in data storage 208.

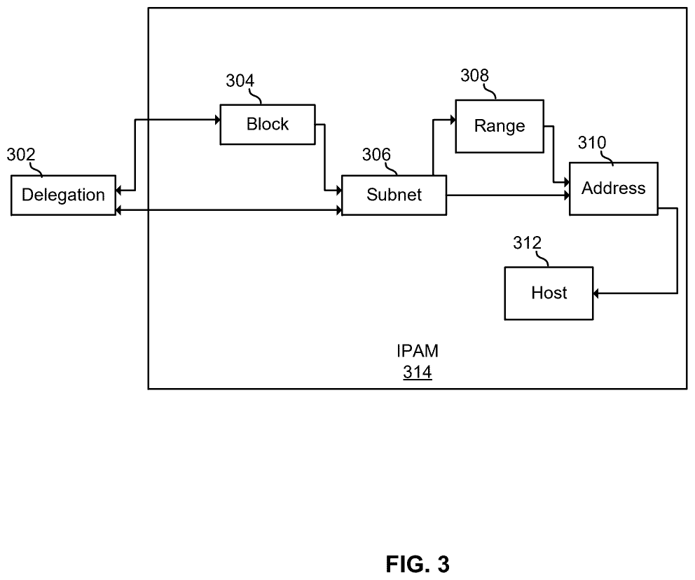

FIG. 3 is a block diagram of an IPAM system in accordance with some embodiments. FIG. 3 demonstrates an example of how a delegation 302 from a federated IPAM system integrates with IPAM 314.

In this example, delegation 302 maintains the mapping to a single block 304 within IPAM 314. However, in various embodiments, delegation 302 may be associated with one or more blocks either within the same IPAM or within one or more different IPAMs.

In some embodiments, a single block 304 is mapped to a single delegation 302. The delegation 302 may have one or more parent federated realms.

Block 304 comprises a block of IP addresses that are planned to be allocated. For example, the subset 10/8 of an address space may be allowed to be used by the West Coast Office of an enterprise. Subnet 306 disposes of the IP addresses available to it. For example, IP address 10.3.4.12/24 is allocated to a printer in the West Coast Office.

Block 304 may have one or more children subnets.

Subnet 306 may have one or more children ranges and/or one or more children addresses.

Under subnet 306 may be range 308 and/or address 310. Range 308 is a range of IP addresses. Range 308 may be allocated to a location on a network that requires more than a single IP address. For example, range 308 may be allocated to one or more webpages associated with a website. Address 310 is an IP address associated with a single host 312. Range 308 may be associated with a plurality of addresses 310 where each address 310 is associated with a host 312.

Host 312 comprises any location on a network that may be associated with an IP address (e.g., a service, device, website, etc.). For example, host 312 can be the printer in the West Coast Office.

Delegation 302 communicates with block 304 and subnet 306 in order to facilitate federated management and/or configuration of IPAM 314. For example, delegation 302 may retrieve the properties of block 304 and forward these properties to an IPAM manager. In another example, delegation 302 changes the properties of subnet 306 (e.g., to allocate one or more IP addresses in subnet 306). This may be facilitated through an IPAM API associated with IPAM 314.

In this illustration, IPAM 314 comprises one block, subnet, range, address, and host. However, it should be understood that IPAM 314 may have multiple instances of each component. This is merely an example of how a single delegation interacts with a single block and subnet.

In some embodiments, subnet 306 may be a child of block 304 where block 304 is a child of delegation 302. However, subnet 306 may comprise be associated with a delegation that is associated with a federated realm other than the federated realm associated with delegation 302.

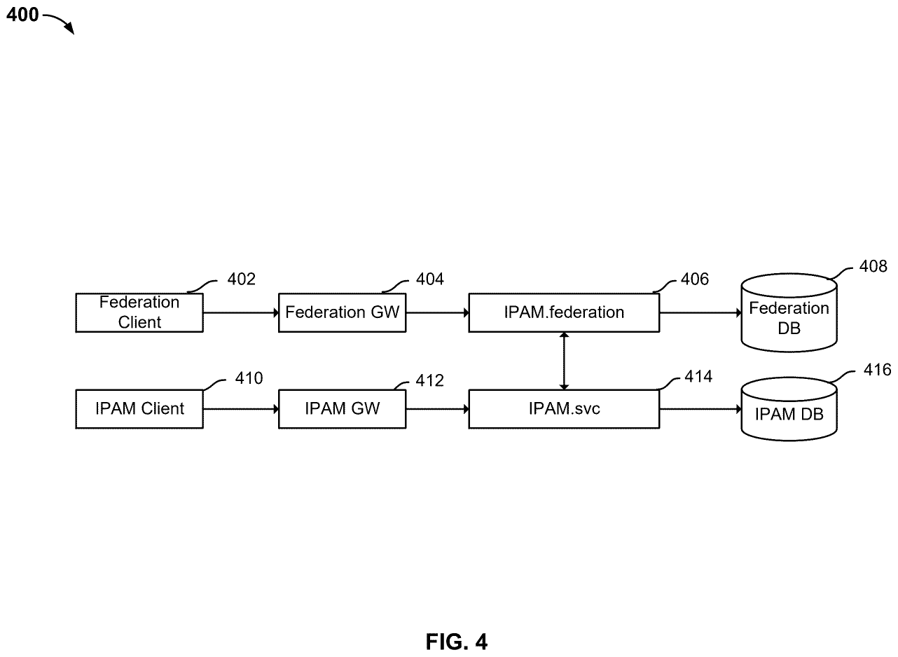

FIG. 4 is a block diagram of an IPAM federation service architecture in accordance with some embodiments. IPAM federation service architecture 400 facilitates IPAM management by a federation client 402 and an IPAM client 410, through use of federation gateway (GW) 404 and IPAM GW 412, respectively.

Federation client 402 is any device which has access to IPAM.federation 406. Federation client 402 may be used by a user (e.g., an IPAM IT specialist) or may be a device which is automatically interfacing with IPAM.federation 406. Federation client 406 may perform a variety of actions with respect to IPAM.federation 406. Examples of actions include configuring a federated IPAM system, viewing properties of a federated IPAM system, managing a federated IPAM system, etc. In some embodiments, federation client 402 interfaces with IPAM.federation 406 using an API.

Federation GW 404 is an intermediary service that facilitates secure communication and data exchange between federation client 402 and IPAM.federation 406. Federation GW 404 may act as a bridge, enabling federation client 402 to access IPAM.federation 406 from various locations. Federation GW 404 may leverage standard protocols such as SAML (Security Assertion Markup Language) or OAuth to manage authentication and authorization across different environments, ensuring seamless single sign-on (SSO) and identity federation.

IPAM.federation 406 is a service that is associated with a federated IPAM system. IPAM.federation 406 may be a standalone service process running in a container (e.g., a Docker™ container) which integrates into other application systems. In some embodiments, IPAM.federation 406 exposes its interface in the form of an API. The API allows federation client 402 to interact with the associated federated IPAM system and perform any actions provided by the API. Examples of actions have been previously described.

IPAM.federation 406 may facilitate the initialization, management, and/or configuration of a federated realm.

In some embodiments, IPAM.federation 406 serves queries from federation client 402 that are authenticated and routed by federation GW 404.

Federation DB 408 is any implementation of a database which is used as a backend by IPAM.federation 406. Federation DB 408 stores all IPAM.federation 406 related data. Examples of related data include any IPAM related data, IP mapping data, security data, etc. Federation DB 408 may store data relating to the definition and properties of one or more federated realms. Federation DB 408 may store data relating to the definition and properties of one or more policy blocks (e.g., federated block, overlapping block, and/or restricted block). Federation DB 408 may also store data relating to the definition and properties of one or more delegations for a federated IPAM system. Federation DB 408 may be used in conjunction with one or more IPAM DB's to store IP related data for one or more IPAM systems.

In some embodiments, each federation object (e.g., federated realms, policy blocks, and delegations) may be described and stored using a row in a table.

IPAM client 410 is any device which has access to IPAM.svc 414. IPAM client 410 may be used by a human user (e.g., an IPAM/Information Technology (IT)/network administrator/specialist) or may be automatically interfacing with IPAM.svc 414. IPAM client 410 may execute a variety of actions using IPAM.svc 414. Examples include configuring an IPAM, managing an IPAM, viewing the properties of an IPAM, etc.

IPAM GW 412 is an intermediary service that facilitates secure communication and data exchange between IPAM client 410 and IPAM.svc 414. IPAM GW 412 may be provided by a CSP associated with IPAM.svc 414. For example, if IPAM.svc 414 is affiliated with AWS™ IPAM, IPAM GW 412 may be an AWS™ gateway.

IPAM.svc 414 is a service that is associated with an IPAM system. The IPAM system may be provided by a CSP or it may be an on-prem IPAM system. IPAM.svc 414 may comprise an API that allows interface with an IPAM service. This API may be accessible by IPAM.federation 406 and by IPAM client 410.

IPAM DB 416 is any implementation of a database which is used as a backend by IPAM.svc 414. IPAM DB 416 stores all IPAM.svc 414 related data. Examples include information related to the allocation, organization, and management of IP addresses within a network. In some embodiments, the usage of both IPv4 and IPv6 addresses is stored in IPAM DB 416, thus ensuring efficient assignment, monitoring, and troubleshooting. IPAM DB 416 may store details such as IP address ranges, subnets, IP address assignments to devices (e.g., servers, printers, computers, etc.), DHCP lease information, and DNS records. IPAM DB 416 may also maintain the status of each address (whether it's free, in use, or reserved), providing network administrators with visibility and control over the IP address space. For example, IPAM DB 416 might store a range of IPs like 192.168.1.0/24, assign the IP address 192.168.1.10 to a server, and record the lease of 192.168.1.20 to a user device for a specified duration.

IPAM.federation 406 and IPAM.svc 414 are connected in order to facilitate an IPAMs inclusion in a federated IPAM system. Data may be transferred from IPAM.svc 414 to IPAM.federation 406 and vice versa. In some embodiments, IPAM.federation 406 makes requests to IPAM.svc 414 for data transfer (e.g., for IP address allocation visibility) and/or requests IPAM.svc 414 to perform an action (e.g., allocating an IP address).

In some embodiments, IPAM.federation 406 sends requests for IPAM.svc 414 to execute an action and waits for IPAM.svc 414 to respond with whether the action is possible/successful. In response to a determination that the action is successful, IPAM.federation 406 may update a representation of the IPAM system, associated with IPAM.svc 414, in federation DB 408.

For example, federation client 402 can request IPAM.federation 406 to allocate a block of IP addresses to an office building. IPAM.federation 406 may send a request to IPAM.svc 414 to determine if the allocation can be made while conforming to one or more policies. IPAM.svc 414 may then allocate the block and respond with success. After this, IPAM.federation 406 may update federation DB 408 to reflect that the allocation has been successful and information about the allocation (e.g., the identification of the IPAM system associated with IPAM.svc 414).

In another example, federation client 402 can use IPAM.federation 406 to delegate an IP address block which is associated with IPAM.svc 414 to a policy block (e.g., to a federated block).

In some embodiments, IPAM client 410 executes an action using IPAM.svc 414. This action may be automatically pulled by IPAM.federation 406 in order to ensure consistency between the IPAM system and the federated IPAM system.

In some embodiments, IPAM.federation 406 is connected to one or more instances of an IPAM.svc. IPAM.federation 406 may coordinate actions with one or more instances of IPAM.svc 414 to implement a federated IPAM system.

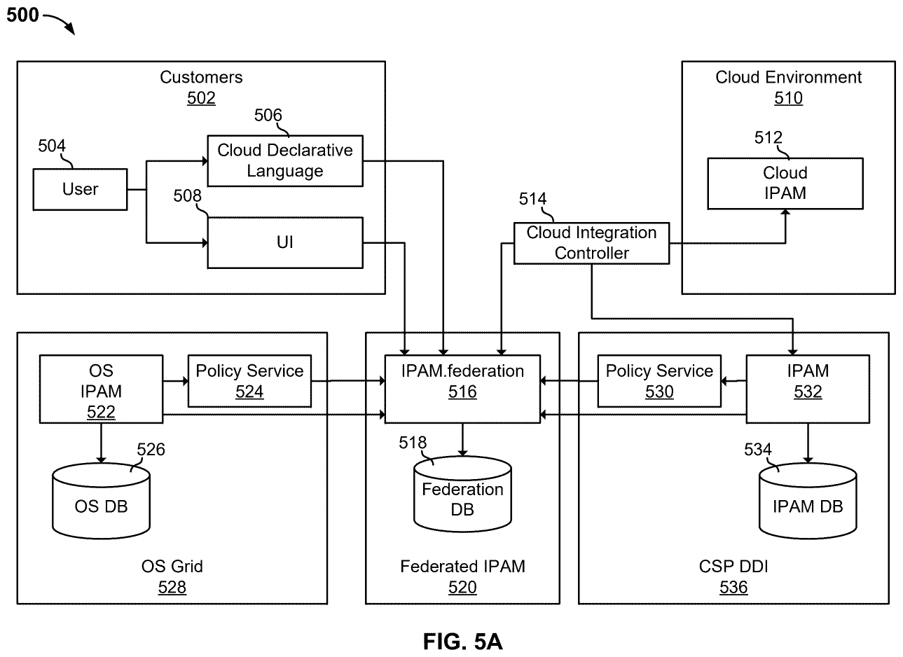

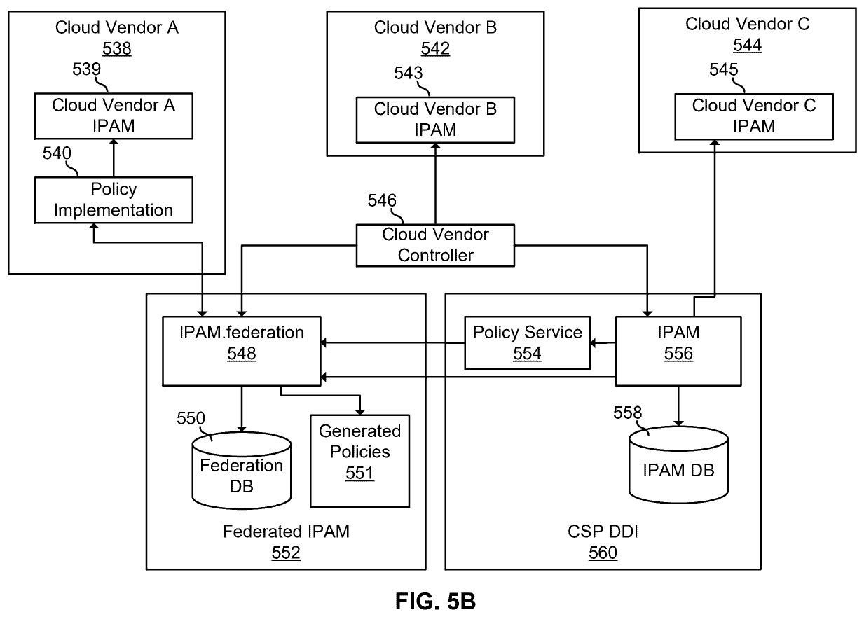

FIG. 5A is a block diagram of a federated IPAM system which includes integration with various components in accordance with some embodiments. Customers 502 use federated IPAM 520 to implement a federated IPAM system with operating system (OS) grid 518 and CSP DNS/DHCP/IPAM (DDI) 536. Cloud environment 510 provides cloud IPAM 512 which may receive IP address policies from IPAM.federation 516.

Integrated federated IPAM system 500 may utilize one or more APIs to integrate federated IPAM 520 with customers 502, cloud environment 510, OS grid 528, and CSP DDI 536. For example, IPAM.federation 516 may use IPAM API calls to retrieve information relating to the connected IPAMs and policy services. Furthermore, user 504 may use a federated IPAM API to interface with federated IPAM 520.

In this example, federated IPAM 520 is integrated with OS grid 528 and a CSP DDI 536. However, in various embodiments, federated IPAM 520 may be integrated with one or more OS grids and/or one or more CSP DDIs.

Customers 502 is an enterprise that uses federated IPAM 520. In this example, customers 502 comprises components that may be used to manage, implement, and/or configure a federated IPAM service.

User 504 is any device associated with customers 502 which interfaces with a federated IPAM system. User 504 may comprise a software executing an automated process. In some embodiments, user 504 uses cloud declarative language 506 (e.g., Terraform™, Ansible™, etc.) to manage, implement and/or configure federated IPAM 520. User 504 may be controlled by a human (e.g., an IPAM IT specialist) or may be a device which is automatically interfacing with federated IPAM 520.

Cloud declarative language 506 can be used for facilitating the management, implementation, and/or configuration of federated IPAM 520 through simple configuration files. Examples of cloud declarative languages include Terraform™ and Ansible™. For example, cloud declarative language 506 allows user 504 to specify the desired state of the network, such as IP address ranges, subnet allocations, and DNS settings. The cloud platform automatically ensures that the infrastructure matches the state specified using cloud declarative language 506. In some embodiments, cloud declarative language 506 uses an API associated with federated IPAM 520 to transform declarations to actions.

User interface (UI) 508 can be used by user 504 to manage, implement, and/or configure a federated IPAM system. UI 508 allows a human user to easily interface with the federated IPAM system without the need for coding. For example, UI 508 may give user 504 a text box, to enter an IP address, and a button, to allocate that IP address. In some embodiments, UI 508 uses an API backend to interface with IPAM.federation 516. In some embodiments, user 504 may use UI 508 to gain visibility into federated IPAM 520.

User 504 may use cloud declarative language 506 and/or UI 508 for facilitating the management, implementation, and/or configuration of federated IPAM 520

Cloud environment 510 is a cloud environment provided by any CSP which provisions space in the cloud for cloud management of an IPAM system. Cloud environment 510 includes cloud IPAM 512.

Cloud IPAM 512 is any implementation of an IPAM system in the cloud. Examples include Amazon Web Services™ (AWS) IPAM and Google Cloud™ Internal Ranges.

Cloud integration controller 514 comprises a system which integrates IPAM.federation 516 and cloud IPAM 512 by sending and receiving information between both systems. In some embodiments, cloud integration controller 514 reads information from cloud IPAM 512. Cloud integration controller 514 may retrieve IPAM related artifacts (e.g., blocks, subnets, addresses, . . . , etc.). The read data may then be projected to data in native DDI terms (e.g., IP spaces, address blocks, subnets, . . . , etc.). Cloud integration controller 514 may be the Google Cloud Provider (GCP)™ Internal Range Controller.

After reading the data, when user 504 requests to make any change (create, update, or delete records), cloud integration controller 514 may be used to perform that an operation associated with the request on cloud IPAM 512, using APIs provided by cloud environment 510.

Federated IPAM 520 comprises a federated IPAM system which is used by customers 502. Federated IPAM 520 may include a federated realm. Federated IPAM 520 may include one or more policy blocks. Federated IPAM 520 may include a delegation. Federated IPAM 520 may include a data modeling service.

IPAM.federation 516 comprises a service that is associated with federated IPAM 520. IPAM.federation 516 may be connected to customers 502, cloud environment 510, OS grid 528, and CSP DDI 536. Customers 502 may manage, configure, and/or implement federated IPAM 520. OS grid 528 and CSP DDI 536 comprise IPAM systems which are federated by federated IPAM 520.

Federation DB 518 is any implementation of a database which is used as a backend by IPAM.federation 516. Federation DB 518 stores all IPAM.federation 516 related data. Examples of related data include any IPAM related data, IP mapping data, security data, etc. Federation DB 518 may store data relating to a federated realm and one or more policy blocks (e.g., federated block, overlapping block, and/or restricted block). Federation DB 518 may store data relating to a delegation for federated IPAM 520.

In some embodiments, cloud integration controller 514 also facilitates an interface between federated IPAM 520 and CSP DDI 536.

Operating system (OS) grid 528 comprises an implementation of an on-prem IPAM system. OS IPAM 522 is used to implement the IPAM system and provide the IPAM service associated with OS grid 528. In some embodiments, OS grid 528 comprises a grid connector which allows for visibility/management of OS IPAM 522 with a broader DDI service. In some embodiments, OS grid 528 is a component of a broader DDI service.

Policy service 524 is a service which facilitates the definition and visibility into how sets of IP addresses (e.g., blocks, subnets, ranges, single IP addresses, etc.) are allocated across OS grid 528. Policy service 524 connects OS IPAM 522 with IPAM.federation 516 and facilitates the inclusion of OS grid 528 into federated IPAM 520. Policy service 524 intercepts every write request made to the OS IPAM 522. It may also generate replies based on an evaluation of policy rules configured within policy service 524. Examples of replies include the following: local, which means that the request can proceed locally; federate, which means the request must be federated; and denied, which means that the request is denied by policy.

For example, suppose a federation request is required to create an object in OS DB 526 (e.g., block, subnet, . . . , etc.) that has been configured with a federated realm. When policy service 524 receives this request (supposing the action can take place), the reply is “federate”.

In some embodiments, federation is not required for a mutation in OS grid 528. For example, when a request to mutate a local address block in OS IPAM 522 is received, policy service 524 will respond with “local” This indicates that the mutation may take place locally without effecting the federated realm. This may be possible when the local address block of OS IPAM 522 already belongs to a delegation.

A federated realm may have some number of reserved blocks. A request to use the resources in those blocks may be denied. For example, if OS IPAM 522 receives a request to utilize resources in a reserved block, the response may be “denied.” This indicates that the mutation is prohibited given the state of federated IPAM 520.

There may be many other policy decisions including custom policy written by the operator. These policies may be used to determine whether the OS may reply with a federate, local, or deny request.

Examples of policies include IP address reservation, subnetting, access control policies, overlapping address prevention policies, etc.

In some embodiments, IPAM.federation 516 checks with policy service 524 before making any change to IP address allocation/delegation.

In some embodiments, policy service 524 comprises an Open Policy Agent (OPA) which may be used to make policy decisions. In some embodiments, OS grid 528 offloads policy decisions to an OPA by executing queries. The OPA evaluates policies and data to produce query results. The results may be forwarded to IPAM.federation 516. Policies may be written in a high-level declarative language and can be loaded dynamically into OPA remotely via APIs or through a local filesystem on OS grid 528.

This implementation allows for consistency between OS grid 528 and federated IPAM 520.

OS DB 526 is any implementation of a database which is used as a backend for OS grid 528. OS DB 526 may store any information relating to OS IPAM 522. Examples include information related to the allocation, organization, and management of IP addresses within a network. OS DB 526 may store details of objects such as IP address ranges, subnets, IP address assignments to devices (e.g., servers, printers, or computers), DHCP lease information, and DNS records. OS DB 526 may also maintain the status of each address (whether it's free, in use, or reserved), providing network administrators with visibility and control over the IP address space.

OS DB 526 may also store information relating to policies. The information relating to policies may be sent by policy service 524 to IPAM.federation 516.

Cloud Service Provider DNS/DHCP/IPAM (CSP DDI) 536 is a DDI system that is provided by a CSP. DNS, DHCP, and IPAM are three core network services that help manage and optimize network infrastructure. DNS (Domain Name System) resolves domain names to IP addresses, allowing devices to communicate using human-readable names. DHCP (Dynamic Host Configuration Protocol) automatically assigns IP addresses to devices on a network, simplifying IP address management. In some embodiments, CSP DDI 536 integrates DNS, DHCP, and IPAM services into a single solution, offering centralized management, increased automation, and improved network visibility. An example of CSP DDI 536 is B1DDI™.

CSP DDI 536 may be implemented in any cloud environment, such as AWS™, GCS™, Azure™, etc.

In this example, components relating to the IPAM system/service of CSP DDI 536 are provided. However, it should be understood that CSP DDI 536 may comprise several other components for using IPAM capabilities with DNS and/or DHCP capabilities.

IPAM 532 is an IPAM system of a CSP DDI 536. In some embodiments, IPAM 532 organizes IP blocks that are hosted by CSP DDI 536. For example, IP blocks may be divided into smaller subnets. Each subnet may be used as blocks of IP addresses that are allocated to groups of devices. Furthermore, each subnet may comprise individual IP addresses which are allocated to individual hosts. CSP DDI 526 may use the IP addresses associated with the IPAM for purposes relating to DNS and/or DHCP.

Policy service 530 is a service which facilitates the definition and visibility into how sets of IP addresses (e.g., blocks, subnets, ranges, single IP addresses, etc.) are allocated across CSP DDI 536. Policy service 530 connects IPAM 532 with IPAM.federation 516 and facilitates the inclusion of CSP DDI 536 into federated IPAM 520. Policy service 530 may include policies relating to the DNS/DHCP functionality of CSP DDI 536. For example, policy service 530 may include polices relating to DHCP lease durations.

Policy service 530 may comprise an OPA. The OPA may use a sidecar configuration.

IPAM DB 534 is any implementation of a database which is used as a backend for CSP DDI 536. IPAM DB 534 may store any information relating to IPAM 532 and/or CSP DDI 536. Examples include information related to the allocation, organization, and management of IP addresses within a network. IPAM DB 534 may store details such as IP address ranges, subnets, IP address assignments to devices (e.g., servers, printers, computers, etc.), DHCP lease information, and DNS records. IPAM DB 534 may also maintain the status of each address (whether it's free, in use, or reserved), providing network administrators with visibility and control over the IP address space.

IPAM DB 534 may also store information relating to the integration of IPAM 532 with other services provided by CSP DDI 536 such as DNS and DHCP.

FIG. 5B is a block diagram of a federated IPAM system which includes integration with different cloud vendors in accordance with some embodiments. In this example, cloud vendor controller 546 integrates cloud vendor A 538, cloud vendor B 542, and cloud vendor C 544 with federated IPAM 548 through IPAM.federation 548. Federated IPAM 552 may include a data modeling service.

Cloud vendor A 538 is a cloud environment from any cloud vendor (e.g., AWS™, Google Cloud™, Azure™, . . . , etc.). Cloud vendor A 538 comprise cloud vendor A IPAM 539. Cloud vendor A IPAM 539 may be ay implementation of a cloud IPAM system. Examples include Amazon Web Services™ (AWS) IPAM and Google Cloud™ Internal Ranges. Cloud vendor A 538 also includes policy implementation 540.

Policy implementation 540 is a service which facilitates the definition and visibility into how sets of IP addresses (e.g., blocks, subnets, ranges, single IP addresses, etc.) are allocated by cloud vendor A IPAM 539. Policy implementation 540 is implemented by cloud vendor A 538. This requires a deeper integration by IPAM.federation 548. Even as a third-party implementation, policy implementation 540 can be configured to send responses and request to integrate into federated IPAM 552. This may be accomplished by IPAM.federation 548 contacting policy implementation 540 to determine the policy for integration in the federation.

Cloud vender controller 546 provides an interface with IPAM.federation 548 and cloud vendor B 542. Cloud vendor B 542 comprises cloud vendor B IPAM 543. In some embodiments, cloud vendor controller 546 uses a public API associated with cloud vendor B 542 in order to execute IPAM related actions on cloud vendor B IPAM. This actions include retrieving information for visibility and applying policies.

Cloud vendor C 544 comprises cloud vendor C IPAM 545. Cloud vendor C IPAM 545 is integrated with IPAM 556 of CSP DDI 560. In this example, CSP DDI 560 performs federation tasks (e.g., tasks related to IPAM.federation 548) by contacting an API associated with cloud vendor C 544. In this example, the policy agent for cloud vendor C IPAM 545 is policy service 554. In some embodiments, IP spaces in cloud vendor C IPAM 545 are modeled as federated realms.

Both cloud vendor A 538 and cloud vendor C 544 demonstrate examples where the integration of a cloud IPAM to federated IPAM 552 is accomplished without the use of a middleman (e.g., cloud vendor controller 546).

Federated IPAM 520 comprises a federated IPAM system. IPAM.federation 516 comprises a service that is associated with federated IPAM 552. Federation DB 550 is any implementation of a database which is used as a backend by IPAM.federation 548. Federation DB 550 stores all IPAM.federation 548 related data. Examples of related data include any IPAM related data, IP mapping data, security data, etc. Federation DB 548 may store data relating to a federated realm and one or more policy blocks (e.g., federated block, overlapping block, and/or restricted block). Federation DB 548 may store data relating to a delegation for federated IPAM 552.

Generated policies 551 is a database which stores all policies relating to federated IPAM 552. These include policies that implemented by the other IPAM systems and their relation to the policies in federated IPAM 552. In some embodiments, generated policies 551 are stored on federation DB 550.

CSP DDI 560 is a DDI system that is provided by a CSP. DNS, DHCP, and IPAM are three core network services that help manage and optimize network infrastructure. IPAM 556 is an IPAM system of a CSP DDI 560. In some embodiments, IPAM 532 organizes IP blocks that are hosted by CSP DDI 536. In this example, IPAM 556 is integrated with cloud vendor C IPAM 545 and shares IP address policies which are regulated by policy service 554.

Policy service 554 is a service which facilitates the definition and visibility into how sets of IP addresses (e.g., blocks, subnets, ranges, single IP addresses, etc.) are allocated across CSP DDI 560. Policy service 554 connects IPAM 556 with IPAM.federation 548 and facilitates the inclusion of CSP DDI 560 into federated IPAM 552.

IPAM DB 558 is any implementation of a database which is used as a backend for CSP DDI 560. IPAM DB 558 may store any information relating to IPAM 556 and/or CSP DDI 560. Examples include information related to the allocation, organization, and management of IP addresses within a network.

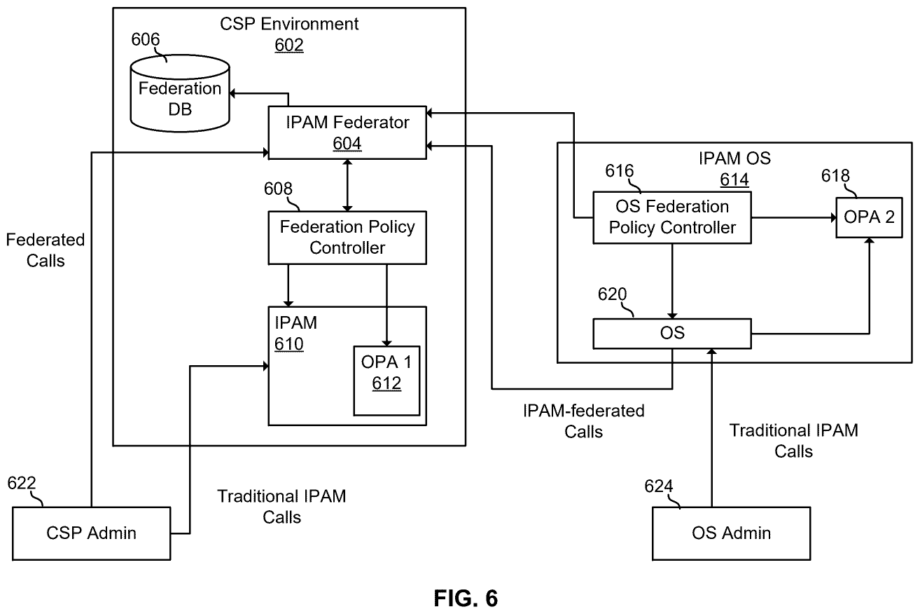

FIG. 6 is a block diagram of a federated IPAM system with an integrated on-prem IPAM system in accordance with some embodiments. In this example, CSP environment 602 includes a federated IPAM system as well as IPAM 610. IPAM federator 604 is associated with a federated IPAM system. CSP Admin 622 may administer IPAM 610 through IPAM calls and IPAM federator 604 through federated calls. OS admin 624 may administer IPAM OS 614 through traditional IPAM calls to OS 620. These calls may be coordinated with IPAM federator 604 through IPAM-federated calls such that the inclusion of the IPAM OS 614 into the federated IPAM system is facilitated. CSP environment 602 may include a data modeling service.

CSP environment 602 is a cloud environment which hosts a federated IPAM system as well as IPAM 610. This example demonstrates that a federated IPAM system and an IPAM may be a part of the same cloud environment. Furthermore, CSP admin 622 may manage both the federated IPAM system and the IPAM. CSP environment 602 may be hosted by any CSP such as AWS™, GCS™, Azure™, etc.

CSP admin 622 is any entity which administers components of CSP environment 602. For example, CSP admin 622 may be a human (e.g., an IT specialist). CSP admin 622 may also be a device configured to automatically interface with CSP environment 602.

CSP admin 622 can make traditional IPAM calls to IPAM 610. This may be facilitated by an API associated with IPAM 610. Examples of traditional IPAM calls include requests to allocate or reserve specific IP addresses for devices or subnets, query available IP address ranges within a subnet, release or deallocate unused IP addresses, configure DNS records linked to specific IP addresses, create or update subnets, retrieve information about the current state of IP address utilization, check for IP conflicts within a network, etc.

CSP admin 622 can also make federated calls to IPAM federator 604. This may be facilitated by an API associated with IPAM federator 604. Examples of federated calls include to generate federated realms, generate policy blocks, generate delegations, visibility into the federated IPAM system, etc.

IPAM federator 604 is a component used to implement a federated IPAM system. In some embodiments, IPAM federator 604 comprises an IPAM.federation. In some embodiments, IPAM federator 604 is an interface which can use federation DB 606 to implement a federated IPAM system in CSP environment 602. For example, federation DB 606 may store data indicating the properties of a federated IPAM system (e.g., federated realms, policy blocks, and/or delegation blocks).

Federation DB 606 is any implementation of a database which is used as a backend for the federated IPAM system associated with IPAM federator 604. Examples of data stored on federation DB 606 include any IPAM related data, IP mapping data, security data, etc. Federation DB 606 may store data relating to a federated realm and one or more policy blocks (e.g., federated block, overlapping block, and/or restricted block). Federation DB 606 may store data relating to a delegation for a federated IPAM system.

Federation policy controller 608 integrates with IPAM 610 and Open Policy Agent (OPA) 1 612. Federation policy controller 608 is used to integrate IPAM policies associated with IPAM 610 with federation policies associated with IPAM federator 604. For example, IPAM policies can indicate an allocation of a particular IP address within an IPAM system. This policy may be stored within a federated IPAM system (e.g., in federation DB 606) along with information describing the association of the allocation with IPAM 610.

In some embodiments, federation policy controller 608 may be used by IPAM federator 604 to effectuate actions (e.g., IP allocations) by IPAM 610. Federation policy controller 608 may also be used to manage federation specific policies. Federation specific policies may include policies relating to federation management of a set of IP addresses, overlapping nature of a set of IP addresses, policies of IP addresses associated with policy blocks, delegations, etc.

In some embodiments, federation policy controller 608 interfaces directly with IPAM 610. This may occur when an OPA is not available for an IPAM service. In some embodiments, federation policy controller 608 interfaces with OPA 1 612 which allows for policy control, as described below.

IPAM 610 is an implementation of an IPAM system within a cloud environment. In some embodiments, IPAM 610 comprises OPA 1 612.

OPA 1 612 is an implementation of an Open Policy Agent which may be used by IPAM 610 to communicate policies with federation policy controller 608. In some embodiments, OPA 1 612 is deployed using a Sidecar implementation in order to exchange policy requests and responses with federation policy controller 608. OPA 1 612 may also be deployed as a host-level daemon or a library. In some embodiments, a service such as IPAM 610 and/or IPAM federator 604 offloads policy decision to OPA 1 612 by executing queries. OPA 1 612 evaluates policies and data to produce query results. Policies may be written in high-level declarative language and can be loaded dynamically into OPA 1 612 remotely via APIs or through the local filesystem.

In some embodiments, IPAM 610 may be a cloud-based IPAM service that is already integrated or can easily be integrated with an OPA. Thus, integrating IPAM 610 with the federated IPAM system can be simplified through the use of OPA 1 612.

OPA 1 612 may also be configured to communicate with OS federation policy controller 616 to facilitate consistency of policies between both systems.

IPAM OS 614 is an implementation of an on-prem IPAM system. IPAM OS 614 comprises any IPAM system and service.

OS 620 is a component responsible for supporting the operation of IPAM OS 614. OS 620 may be any operating system which can be used to implement an IPAM system such as NIOS™, Linux™, Windows™, etc. OS 620 may comprise an OS grid connector which facilitates visibility of the IPAM system with a broader DDI system.

OS 620 may be controlled by OS federation policy controller 616 and OS admin 624. For example, requests to allocate a set of IP addresses may be sent by either OS federation policy controller 616 or OS admin 624. Furthermore, policy management for IPAM OS 614 may be facilitated by OPA 2 618.

In some embodiments, OS 620 may directly interface with IPAM federator 604 by sending IPAM-federated calls. IPAM-federated calls comprise federated calls relating to federation of the IP addresses associated with IPAM OS 614. This may include calls to federate IP addresses that are already allocated by IPAM OS 614.

OS federation policy controller 616 integrates with OS 620 and OPA 2 618. OS federation policy controller 616 is used to integrate IPAM policies associated with IPAM OS 614 with policies associated with IPAM federator 604. For example, IPAM policies can indicate an allocation of a particular IP address within IPAM OS 614. In some embodiments, policies are retrieved from IPAM federator 604 and cached by OS federation policy controller 616.

In some embodiments, OS federation policy controller 616 makes read requests to IPAM federator 604. The read requests may be reading the policy records of IPAM 610. These policies may be used to set policy by OPA 2 618. When OPA 2 receives the read requests, it will determine whether the policy can be implemented by IPAM OS 614. OS 620 will read from OPA 2 whether the policies can be implemented. OS 620 can then make IPAM-federated calls to IPAM federator 604 based on how the policy may be implemented on IPAM OS 614.

Examples of IPAM-federated calls include Create, GetNextAvailable, Update, Delete, Import, Copy, Restore, . . . , etc. Create is used to create an object on a federated IPAM system (e.g., a federated realm, policy blocks, delegations, etc.). GetNextAvaiable is used to determine what IP address space is available for allocation. GetNextAvailable may be used to allocate any IP address space (e.g., blocks, subnets, ranges, and/or individual IP addresses). This technique may be used for any policy block and/or delegation. For example, if CSP admin 622 wants to add a subnet to a federation block and allocate it for use in a branch office, the CSP admin 622 can send a GetNextAvailable federated call. This will provide a subnet for that purpose.

Update may be used to mutate an IP address block, such as adding/removing IP address and/or reallocating IP addresses. Delete is used to delete an IP address space or delete a federated object.

Import may be used to import objects (e.g., federation objects and/or IP address objects) in bulk. Copy can be used to copy an object into a new one. Restore is the opposite action of delete. This can be done to restore a deleted object.

OPA 2 618 is an implementation of an Open Policy Agent which may be used by IPAM OS 614 to communicate policies with OS federation policy controller 616. In some embodiments, OPA 2 618 is deployed using a Sidecar implementation in order to exchange policy requests and responses with OS federation policy controller 616. OPA 2 618 may also be deployed as a host-level daemon or a library. In some embodiments, OS 620 and/or IPAM federator 604 offload policy decisions to OPA 2 618 by executing queries. OPA 2 618 evaluates policies and data to produce query results. Policies may be written in high-level declarative language and can be loaded dynamically into OPA 2 618 remotely via APIs or through the local filesystem.

OS admin 624 is any entity which administers components of IPAM OS 614. For example, OS admin 624 may be a human (e.g., an IT specialist). OS admin 624 may also be a device configured to automatically interface with IPAM OS 614. OS admin 624 can make traditional IPAM calls to OS 620. This may be facilitated by an API associated with IPAM OS 614. Examples of traditional IPAM calls include requests to allocate or reserve specific IP addresses for devices or subnets, query available IP address ranges within a subnet, etc.

In this example, a single cloud-based IPAM and a single OS-based IPAM are displayed. However, in various embodiments, there may be one or more cloud-based IPAMs and/or one or more OS-based IPAMs. The one or more IPAMs may be integrated with IPAM federator 604 in a similar manner as provided.

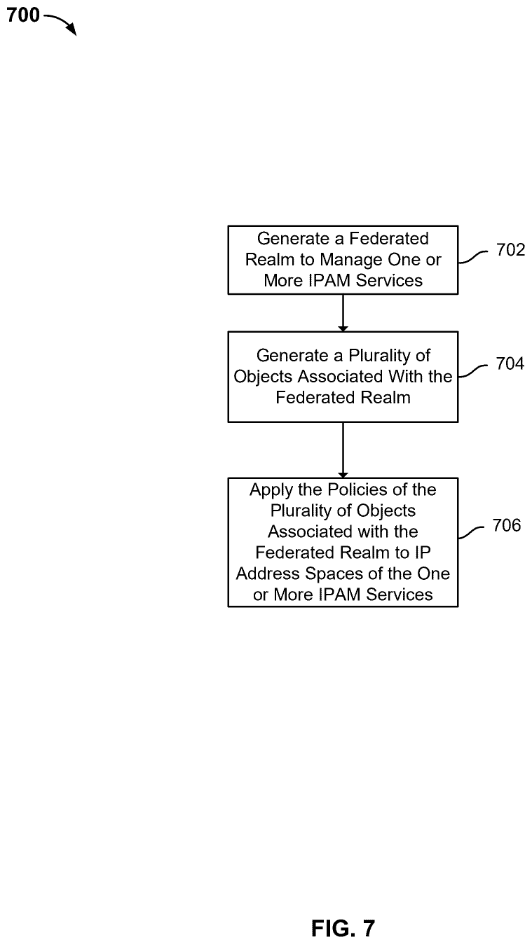

FIG. 7 is a flow diagram of a process for implementing a federated IPAM system in accordance with some embodiments. Process 700 may be implemented using any embodiment of a federated IPAM system. In some embodiments, process 700 may be executed by an IPAM manager, an admin, a client, and/or a user. Each step of process 700 may be executed with the use of an API. In some embodiments, a UI or a cloud declarative language is used to direct an API to execute the steps of process 700. In some embodiments, process 700 allocates resources in the cloud.

At 702, a federated realm is generated to manage one or more IPAM services. A Federated realm comprises a set of all possible IP addresses in any IP protocol version (e.g., IPv4 and/or IPv6), regardless of the address usage. A federated realm signifies that resources within its address blocks are reachable (from an IP perspective) with other resources in other address blocks. It orchestrates the connection pathways and ensures that they are logically defined.

The federated realm retains root authority over all IP address blocks associated with the federated realm. In some embodiments, the federated realm serves as a named container for a group of objects, establishing a distinct namespace for IPv4 and/or IPv6 addressing. The federated realm allows an enterprise to use a common shared address space with no collisions, where IP addresses are spread across different IP spaces and/or managed in different IPAMs. The federated realm may be generated by using a POST method associated with a federated realm API endpoint. The federated realm may be managed and/or configured by interfacing with the same API through one or more endpoints.

At 704, a plurality of objects associated with the federated realm is generated. Objects associated with the federated realm include policy blocks and delegations. Examples of policy blocks include a federated block, an overlapping block, and a reserved block. Each of the enumerated policy blocks have certain policies associated with them. Each of the policy blocks may be associated with a CIDR notation. Each of the blocks may be generated by executing an API call (e.g., a POST method) with an API endpoint associated with the block type. A federated block represents a set of contiguous IP addresses in the federated realm. A federated block may denote the available network space on one or more IPAMs.

Objects may include federation objects.

An overlapping block represents an IP address range for which authority is expressly abandoned by all IPAMs associated with the federated realm. In some embodiments, IP addresses in overlapping blocks may be used to perform local operations.

A reserved block represents an address space for which usage is restricted. For example, IP addresses in a reserved block may be restricted from allocation/usage by one or more IPAMs.

Delegation objects can be used to indicate that the authority of IP address spaces in the federated realm (e.g., that of a federated block) belongs to one of the one or more IPAM services.

An API may be used to generate an object associated with the federated realm. For example, to generate a federated block, a POST method is used with a federated block API endpoint that is associated with the federated realm.

At 706 policies of the plurality of objects associated with the federated realm are applied to IP address spaces of the one or more IPAM services. Each of the objects associated with the federated realm are associated with one or more policies (e.g., a reserved block is associated with a reserved policy). Application of policies may include a process which involves communications between an IPAM service and the federated IPAM system associated with the federated realm. An example of such a process is process 800.

In some embodiments, the policy of a policy block may be applied to one or more IPAM address spaces by informing policy service component on the IPAM to match an IP address space to an IP address space of a federated realm.

For example, when a federated block for IP address space 192.168.0.0/24 is created, the policy may be applied by asking the IPAMs to federate with the federated block when the IPAM tries to allocate one or more IP addresses in the IP address space 192.168.0.0/24. The federated realm may respond with success or failure. A successful response may occur when the IP address space is free to use (e.g., it has not been allocated by other IPAMs).

Application of policies may include utilizing a public API associated with an IPAM service. Application of policies may also include interfacing with a policy service associated with an IPAM service.

Examples of IP address spaces associated with the one or more IPAM services include blocks, subnets, ranges, and individual IP addresses. In some embodiments, the one or more IPAM address spaces are associated with one or more different IPAM systems/services. The IPAM systems/services may be on-prem and/or hosted in the cloud.

After using process 700 to implement a federated IPAM system, an enterprise may use the federated IPAM system to federate the one or more IPAMs associated with the IPAM IP address spaces.

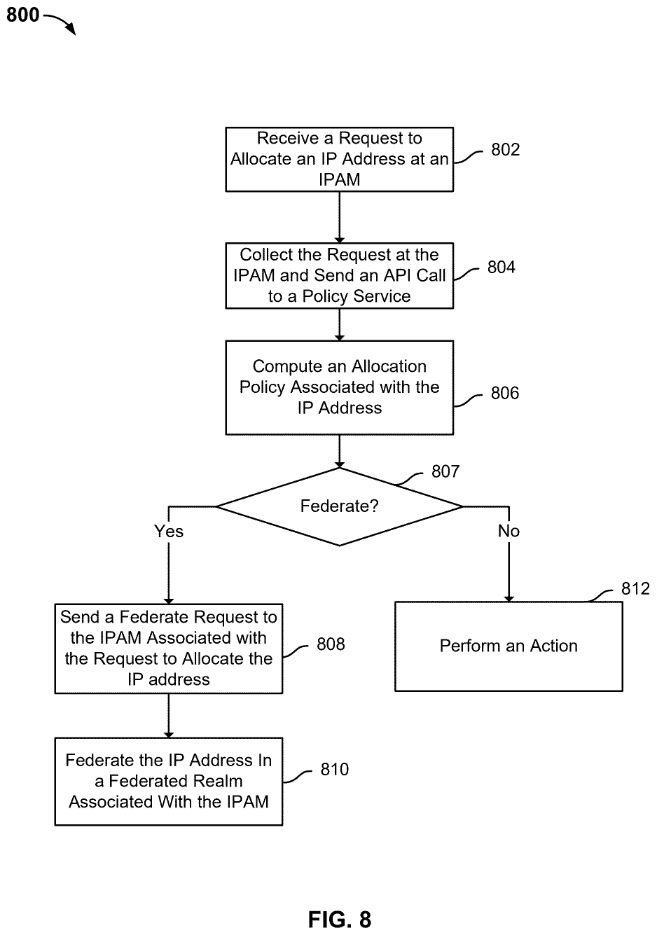

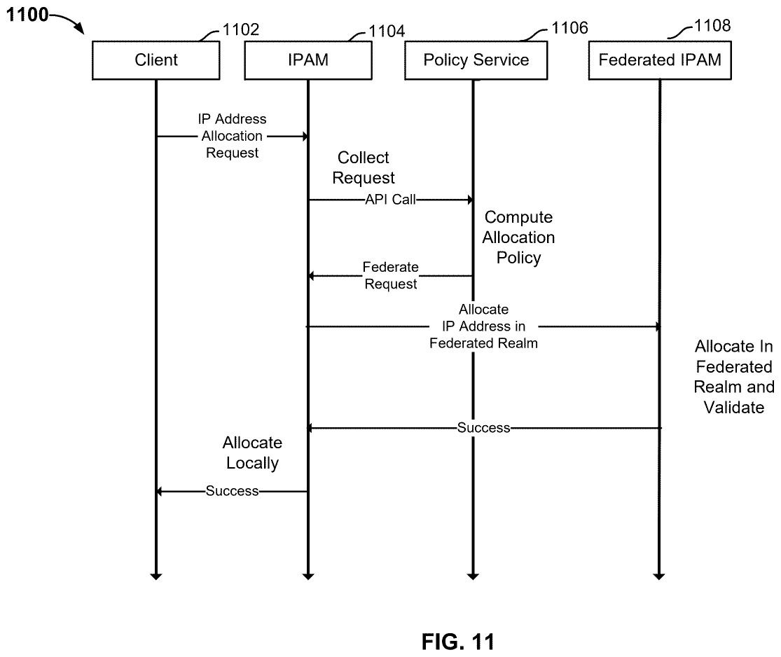

FIG. 8 is a flow diagram of a process for allocating an IP address using a federated IPAM system in accordance with some embodiments. In some embodiments, a part or the whole of process 800 is executed by an IPAM system in the context of a federated IPAM system. FIG. 11 provides an example execution of this process using a sequence diagram.

At 802, a request is received to allocate an IP address. The request may be received at an IPAM system/service. The request may be sent from a client to the IPAM system/service. The request may comprise a POST request to create an IP address, assign a prefix, and/or associate the IP address in a particular federated realm. The request may be sent by an IPAM manager, an admin, a client, and/or a user. In some embodiments, the sender of the request is an automated device. In some embodiments, the sender of the request is a human using a device. An example of the request is a POST request to generate 10.0.1.0/24 and place it in the Federated Realm Foo. This may be facilitated using an API associated with the IPAM system/service.

At 804, the request is collected at the IPAM and an API call is sent to a policy service. In some embodiments, the policy service is a component of the IPAM. The policy service may comprise an OPA. The OPA may use a sidecar implementation. Collecting the request comprises extracting the relevant data for further processing. Relevant data associated with the request may then be sent to a policy service in the form of an API call. The relevant data may comprise the IP address, information associated with the properties of the IP address in the context of an IPAM (e.g., which block, subnet, range, etc. the IP address is associated with), the policy information, information associated with where (e.g., what host) the IP address is requested to be allocated to, etc. In some embodiments, the policy service is a component of the IPAM. The policy service may comprise an OPA. The OPA may use a sidecar configuration. For example, the IPAM can be configured in the cloud with an OPA sidecar

At 806, an allocation policy associated with the IP address is computed. The allocation policy may be computed at a policy service associated with the IPAM. The policy service may be a component of the IPAM. The policy service may comprise an OPA. The OPA may use a sidecar implementation. In some embodiments, the allocation policy defines the rules and guidelines for how IP addresses are assigned or distributed within a network. In some embodiments, the allocation policy includes criteria such as whether the IP address is allocated dynamically (e.g., through DHCP), statically (manual assignment), or from a predefined address pool. In some embodiments, the policy service is updated such that it knows the policies of IP address space within the broader context of a federated IPAM system. For example, the policy service may be updated through communication with a federation service. In some embodiments, the computation of the allocation policy considers the broader federated IPAM system. For example, a request may be denied if the request asks to use an IP address within a restricted block.

At 807, whether the allocation policy is federate is determined. The IPAM may be unable to allocate the IP address due to restrictions locally. In some embodiments, a federated IPAM system associated with the IPAM has configured a local policy service from allocating the IP address. In response to a determination that the allocation policy associated with the IP address is federate, process 800 proceeds to step 808. In response to a determination that the computation policy is not federate, process 800 proceeds to step 812.

At 808, a federate request associated with the request to allocate the IP address is sent. In some embodiments, a policy service sends the federate request to the IPAM system. In some embodiments, the federate request is sent after the policy service determines it is possible to federate the IP address within the IPAM system. For example, the federate request can be sent after a determination is made that the allocation will not cause a collision within the IPAM system.

In some embodiments, the federate request is sent to the IPAM system in order to begin the process of federating the IP address. Federating the IP address requires coordination between the IPAM system and a broader federated IPAM system.

At 810, the IP address is federated in a federated realm associated with the IPAM. In some embodiments, after an allocation policy is computed by a policy service, a federated IPAM system associated with the IPAM executes a process to federate the IP address in the federated realm. In some embodiments, the IPAM receives the request to federate from the policy service. The IPAM responds to the federate request by sending a request to a federated IPAM system. The IP address is allocated in the federated realm. Then the IP address is allocated locally in the IPAM. After this, the IP address is delegated between the IPAM system and the federated IPAM system. For example, the IP address may be allocated in a policy block (and mapped to an IP address that is allocated locally in the IPAM.

The federate request of step 808 may be processed by the IPAM depending on the context of the request (e.g., an associated IPAM action). For example, if the federate request is made in the context of the Create IPAM action, federate means that the IPAM must request a matching delegation, and it must succeed before creating the record.

At 812, the policy service performs an action. The policy service may send other requests. One such request is the local request. The local request informs the IPAM to proceed with the operation (e.g., allocation) as it would if it were not part of a federated IPAM system (e.g., proceed with the operation locally). This may be sent to inform the IPAM to locally manage requests that have no bearing on the federation. In some embodiments, the local request is sent when the parent blocks of the IP address are already federated. This may occur when the IP address is associated with an overlapping block.

Another type of request that may be sent is the deny request, which tells the IPAM system to not perform the action. This may occur when the action is attempting to allocate reserved IP space (e.g., an IP address in a reserved block).

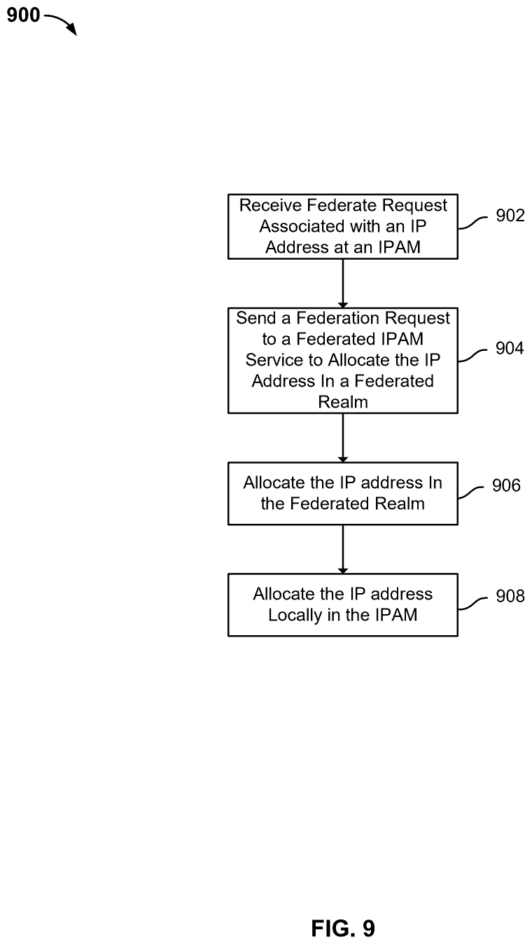

FIG. 9 is a flow diagram of a process for federating an IP address in a federated realm in accordance with some embodiments. Process 900 may take place within a federated IPAM system. Part or all of step 810 may be executed by process 900. FIG. 11 provides an example of how some or all steps of process 900 are executed in a sequence diagram.

At 902, a federate request associated with an IP address is received at an IPAM. The request to federate may have been sent by a policy service after an allocation policy was computed for the allocation of an IP address. In some embodiments, the policy service is a part of the IPAM. A federate request may comprise a request for the IPAM to send a federation request to a federated IPAM system/service prior to allocating the IP address locally. This may occur when the policy service knows that the IP address can be allocated in a policy block and the IPAM.

At 904, a federation request is sent to a federated IPAM service to allocate the IP address in a federated realm. The federated IPAM service is associated with the IPAM. For example, the IPAM may be a part of the federation. A federated IPAM system may comprise the federation IPAM service. As an illustration, the federation request may comprise a POST to generate 10.0.1.0/24 in the Federated Realm Foo. In some embodiments, the federated IPAM service associated with the federated realm validates the federation request. Validating the federation request may comprise ensuring that the IP address may be allocated in the federated realm and still conform to one or more policies. For example, validating the IP address can include ensuring that the IP address does not overlap with another IP address in a federated block. In another example, validating may comprise ensuring that the IP address does not allocate an IP address in a reserved block.

At 906, the IP address is allocated in the federated realm. Allocation in the federated realm may comprise including the IP address in a policy block and mapping the IP address to the IPAM using a delegation. In some embodiments, once the federated IPAM system successfully allocates the IP address, a response indicating success is sent to the IPAM. Allocating an IP address in a federated realm may comprise storing a record of the IP address in a database associated with the federated IPAM system.

At 908, the IP address is allocated locally in the IPAM. Allocating the IP address locally in the IPAM may comprise assigning the IP address to a subnet, range, and/or host.

In some embodiments, following step 908, a success response is forwarded to the client that initiated the IP address process. The client may consist of an automated process or a human resource. The client may be an IPAM manager or a user. In some embodiments, an automated process continues upon the client receiving a success response. This automated process may comprise allocating other IP addresses. For example, if the first IP address is part of a set of IP addresses, the automated process can continue by allocating the rest of the set of IP addresses.

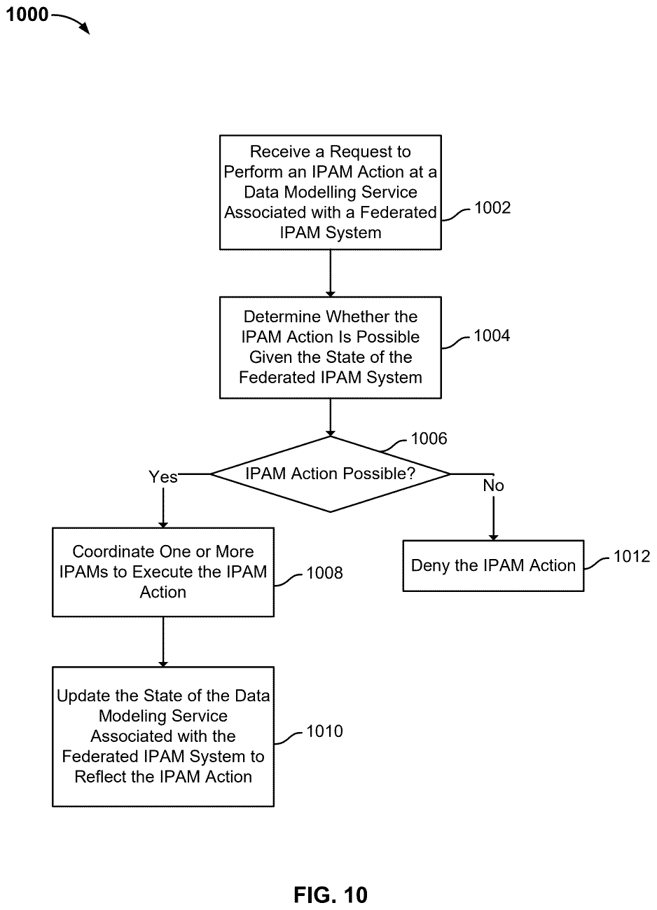

FIG. 10 is a flow diagram of a process for performing an IPAM action in the context of a federated IPAM system in accordance with some embodiments. Process 1000 may be executed by one or more components of a federated IPAM system. Process 1000 uses a data modeling service associated with a federated IPAM system.

At 1002, a request to perform an IPAM action is received at a data modeling service associated with a federated IPAM system. An example of a data modeling service associated with a federated IPAM system is provided in FIG. 2. The request may be sent by a client, an IPAM manager, or a user. The request may be from a human or from an automated service. An IPAM action may be any action relating to the use of a set of IP addresses (e.g., a block, a subnet, a range, and/or an individual IP address) associated with one or more IPAMs. IPAM actions may involve visibility, mutability, compliance, and/or reporting.

Examples include creating a delegation (e.g., between a policy block and an IPAM IP address block), allocating one or more IP addresses, using an IP address, disposing of an IP address, viewing the properties of one or more IPAMs, etc. For example, an action can be a request to create a subnet and delegate the subnet between an IPAM and the federated IPAM system.

The request may be facilitated by an API such as API 206. IPAM actions may comprise POST calls such as a POST call to allocate an IP address.

Other examples of IPAM actions include the following: Create, GetNextAvailable, Update, Delete, Import, Copy, Restore, . . . , etc.

At 1004, whether or not the IPAM action is permissible (e.g., allowed based on a policy) given the state of the federated IPAM system is determined. The permissibility/allowability of the IPAM action may rely on one or more policies associated with sets of IP addresses. For example, an action to create an overlapping IP address may be impermissible if the IP address is in a federated block. An action that will cause an error and/or a misallocation may also be impermissible. An example of a permissible action is creating a subnet in one of the IPAM systems and delegating the subnet with a delegation in the federated IPAM system. The state of the IPAM system may be reflected in a data storage associated with the federation service (e.g., data storage 208). The state of the federated IPAM system may be reflected by the federation objects.

At 1006, in response to a determination that the IPAM action is permissible, process 1000 proceeds to step 1008. In response to a determination that the IPAM action is impermissible, process 1000 proceeds to 1012.

At 1008, one or more IPAMs are coordinated to execute the IPAM action. This may be done by sending API calls to one or more IPAM APIs. In some embodiments, one IPAM is involved in executing the IPAM action. For example, creating a delegation for an IP address space of an IPAM only requires sending API calls to the single IPAM. The API call may comprise a request to ensure policy consistencies between to the IP address space and the delegation. Thus, if a mutation on the IP address space is requested, the IPAM will check with the federated IPAM system to ensure consistency. This API call may be sent to a policy service associated with the IPAM.

In some embodiments, an IPAM action comprises allocating an IP address under an overlapping policy. This means that IP address may be allocated to two or more IPAMs.

In some embodiments, an IPAM action comprises allocating one or more IP addresses. This includes allocating a block, subnet, range, etc.

In some embodiments, two or more IPAMs are coordinated to execute an action. For example, IP address spaces on two or more IPAMs can be assigned to a federated block. Each IPAM may receive separate API calls. Each API calls may comprise a request to ensure policy consistencies between the IPAM and the federated block.

At 1010, the state of the federated IPAM system is updated to reflect the IPAM action. For example, suppose a federated block is created and mapped to a block on an IPAM. A data storage is updated to reflect the change in the IPAM and the federated IPAM system is updated to reflect the creation of the federation block and the mapping. Now, when a mutation associated with the IPAM is requested, the IPAM coordinates with the federated IPAM system using the federation block's policies to execute the action.

In another example, if a set of IP addresses is allocated to IPAM 1, policies will be implemented such that an attempt to allocate any one of the set of IP addresses to IPAM 2 is denied.

At 1012, the IPAM action is denied. This may comprise sending a denied/rejected response to a client. This may occur when the IPAM action is impossible given the state of the federated IPAM system. For example, if the IPAM action comprises a request to allocate an IP address in a restricted block, the request may be denied. This may also occur because the IPAM itself is unable to satisfy the request.

FIG. 11 is a sequence diagram 1100 for allocating an IP address using a federated IPAM system in accordance with some embodiments. Client 1102 may be an IPAM manager or a user. In some embodiments, client 1102 executes this process automatically. In some embodiments, client 1102 is directed by a human. IPAM 1104 may comprise an IPAM system and/or IPAM service. Policy service 1106 may comprise an OPA. The OPA may use a sidecar configuration. Federated IPAM 1108 may comprise a federated IPAM system and/or service.

Client 1102 sends a request to allocate an IP address. The request may comprise an API call using a POST method. For example, the request may be a POST request to generate 10.0.1.0/24 and place it in the Federated Realm Foo.

IPAM 1104 may collect the request. Collecting the request may comprise collecting an API call. Collecting an API call comprises extracting the relevant data for further processing. Relevant data associated with the API call may then be sent to a policy service. The relevant data may comprise the IP address, information associated with where the IP address is in a structure of IP addresses (e.g., which block, subnet, range, etc.), the policy information, information associated with where (e.g., what host) the IP address is requested to be allocated to, etc.

IPAM 1104 creates an API call associated with the request to allocate the IP address and sends the API call to a policy service. The API call may comprise the relevant data collected from the associated request.

Policy service 1106 computes an allocation policy associated with the API call sent by IPAM 1104. In some embodiments, the allocation policy defines the rules and guidelines for how IP addresses are assigned or distributed within a network. In some embodiments, the allocation policy includes criteria such as whether the IP address is allocated dynamically (e.g., through DHCP), statically (manual assignment), or from a predefined address pool.

After computing the allocation policy, policy service 1106 sends a federate request to IPAM 1104. In some embodiments, the federate request is sent after the policy service determines it is possible to federate the IP address within IPAM 1104. For example, the federate request can be sent after a determination that the allocation will not cause a collision within IPAM 1104. The federate request may comprise an API call which is facilitated by an API associated with policy service 1106 and IPAM 1104.

In response to receiving a federate request, IPAM 1104 sends a request to allocate the IP address in a federated realm of the one or more federated realms associated with federated IPAM 1108. This request may comprise an API call that is facilitated by an API associated with IPAM 1104 and an API associated with federated IPAM 1108. For example, the request can include a POST call to generate 10.0.1.0/24 in realm Foo.

Federated IPAM 1108 receives the request to allocate an IP address in a federated realm. In response to receiving this request, federated IPAM 1108 allocates the IP address in the federated realm. Allocating the IP address in the federated realm comprises allocating the IP address in a policy block and delegating the IP address between federated IPAM 1108 and IPAM 1104. In response to a determination that the allocation of the IP address in the federated realm is successful, federated IPAM 1108 sends a success response to IPAM 1104.

IPAM 1104 receives the success response and allocates the IP address locally. Allocating the IP address locally may comprise assigning the IP address to a host.

After successfully allocating the IP address locally, IPAM 1104 sends a success response to client 1102. The IP address is now allocated locally and within the scope of a federated realm. In some embodiments, after the IP address is successfully allocated, client 1102 continues an automated process. The automated process may comprise allocating two or more IP addresses. For example, the process of allocating a set of IP addresses (e.g., a block, a subnet, a range, etc.) may be continued.

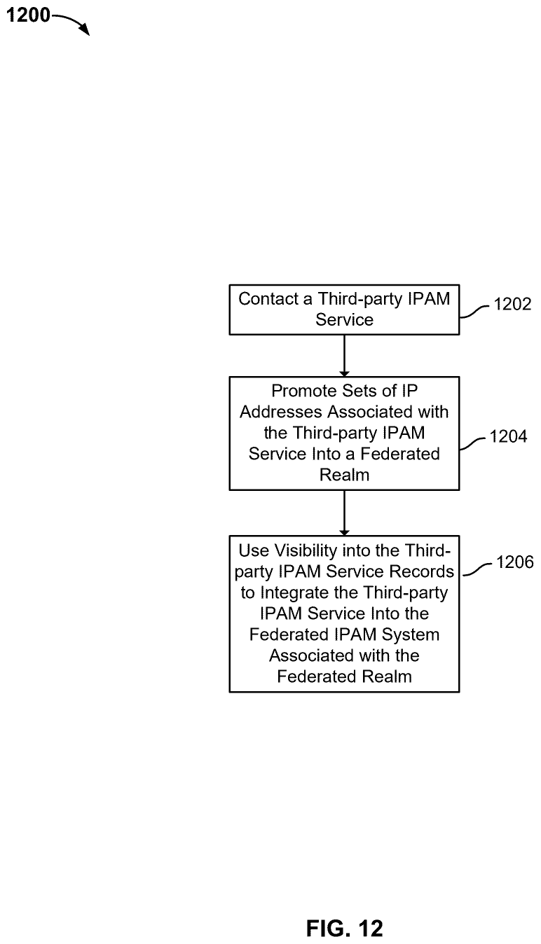

FIG. 12 is a flow diagram of a process for integrating a third-party IPAM service into a federated IPAM system. Process 1200 may be used to provide visibility into one or more IPAM services for further configuration by a federated IPAM service. Process 1200 may occur following the establishment of a federated IPAM system. Process 1200 may occur prior to further configuration of a federated IPAM system. Further configuration may include delegating one or more IP addresses.

At 1202, a third-party IPAM service is contacted. The third-party IPAM service may be an on-prem IPAM or a cloud-based IPAM. In some embodiments, a third-party IPAM service requires that a client, IPAM manager, user, etc. contacts the service in order to make mutations to the underlying structure of the IPAM (e.g., changing/allocating sets of IP addresses).

At 1204, sets of IP addresses associated the third-party IPAM service are promoted into the federated realm. With visibility into the third-party IPAM service, a federated IPAM system can map/store the sets of IP addresses within the third-party IPAM service. Promotion of IP address sets may comprise storing the sets of IP addresses in a database (e.g., a data storage 208). This step may comprise creating a federated record of utilized and disposed IP address space. Utilized address space may comprise IP address space that can be allocated or that the IPAM system plans to allocate from the perspective of the federated realm. In some embodiments, utilized address space may comprise IP address space in a block. Disposed IP address space comprises address space that is being used by the third-party IPAM from the perspective of the federated realm (e.g., delegating a federated block to a block on the third-party IPAM). In some embodiments, subnets comprise IP address space that has been disposed.

At 1206, the visibility into the third-party IPAM service records is used to integrate the third-party IPAM service into the federated IPAM system associated with the federated realm. The visibility allows the federated IPAM service to determine what IP address space is usable and what IP address space is unusable. This allows the federated IPAM system to use the IP address space of the third-party IPAM system. For example, if 10.0.2.0 is not used in the IPAM system, it can be marked as available in aa policy block.

In some embodiments, this visibility is used by the federated IPAM system to determine which subnets must be renumbered. Renumbering a subnet comprises changing the IP address range which is assigned to the subnet. This may be done to effectuate network reorganization, expansion, and/or reallocation of resources.

The identification of the third-party IPAM records enables dynamic addressing, policy enforcement, and delegation. Prefixes may be identified to be reachable across organizational units, such as Virtual Private Computers (VPCs). In some embodiments, the data received from this identification can be used as inputs to enforcement systems.

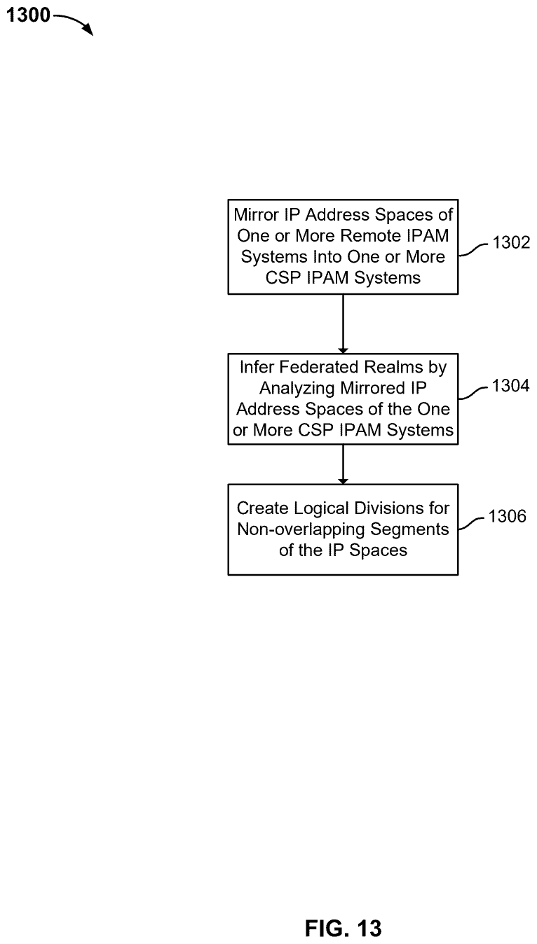

FIG. 13 is a flow diagram for a process for mirroring and/or inferring federated realms from one or more CSP IPAM systems. Process 1300 may be used with a federated IPAM system that has been initiated and is associated with one or more IPAM systems. In some embodiments, process 1300 facilitates the integration of remote IPAM systems into a federated IPAM system. Process 1300 may be executed to enhance the synchronization and/or management of IPAM systems across different environments.

At 1302, IP address spaces of one or more remote IPAM systems are mirrored into one or more CSP IPAM systems. A remote IPAM system may comprise an on-prem IPAM system. Examples include an IPAM OS or an OS grid. In some embodiments, an IP address space comprises all IP addresses managed by an IPAM system of the one or more remote IPAM systems. An IP address space may comprise a set of IP addresses (e.g., a block, subnet, range, and/or single IP address). Mirroring IP address spaces comprises creating representations of the address blocks in the CSP IPAM systems. For example, if an IPAM system includes the IP address block of 192.168.0.0 to 192.168.0.255, then a mirrored address block will also include a block of IP addresses that can map to this block. The mirrored IP address space can be stored with information indicating which IPAM system comprises the original address block.

At 1304, federated realms are inferred by analyzing the mirrored IP address spaces of the one or more CSP IPAM systems. Federated realms may be inferred by inferring the required federation polices associated with the imported IP address spaces of the one or more CSP IPAM systems. For example, if there are overlapping IP addresses in some spaces, two or more federated realms may be created. These federated realms may be initiated with overlapping blocks as required.

At 1306, logical divisions for non-overlapping segments of the IP spaces are created. In some embodiments, the IP spaces may be split into federated blocks. Each federated block may be delegated to a corresponding IPAM block in a non-overlapping manner. For example, a federated block with IP addresses comprising 192.168.1.0/24 can be allocated to CSP IPAM block 1 and a federated block with IP addresses 10.0.0.0/16 can be allocated to CSP IPAM block 2.

Using this process, redundancies in the one or more remote IPAM systems may be reduced. For example, if two IPAM systems include an IP address for a single device, the two IP addresses can be merged.

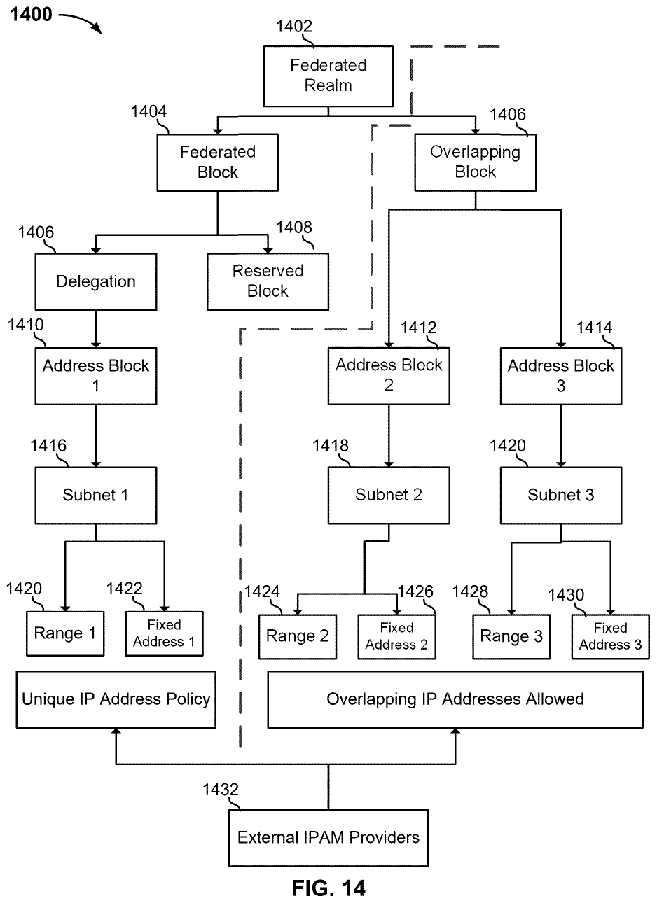

FIG. 14 is a block diagram of a configuration of a federated IPAM system in accordance with some embodiments. Federated IPAM system 1400 demonstrates an example of how a federated realm 1402 can be comprised of two policy blocks, federated block 1404 and an overlapping block 1405. Each block may be a set of IP addresses with certain policies. In this example, overlapping block 1405 and its constituents are split into a segment that is associated with a policy that allows for overlapping IP addresses. Federated block 1404 and its constituents are split into a segment that is associated with a policy that only allows for unique IP address allocation. The IP addresses for each block are provided by external IPAM providers 1432. External IPAM providers 1432 comprise IPAM systems/services which provide sets of IP addresses.

Federated block 1404 may comprise delegation 1406 and reserved block 1408. Reserved block 1408 comprises IP addresses associated with federated realm 1402 which cannot be allocated by external IPAM providers 1432.

Delegation 1406 indicates that authority with address block 1 1410 belongs to federated block 1404. This provides federated realm 1402 with the resources (e.g., IP addresses) of external IPAM providers 1432 for use in IP allocation. Delegation 1406 is configured to map address block 1 1410 to federated block 1404. Address block 1 1410 may comprise a block of IP addresses that are planned to be allocated.

Address block 1 1410 comprises subnet 1 1416. Subnet 1 1416 comprises a set of IP addresses that are allocated or may be allocated.

There may be two or more address blocks which are mapped to one or more federated blocks through delegation 1406. Further, address block 1 1410 may comprise two or more subnets.

Subnet 1 1416 comprises range 1 1420 and fixed address 1 1422. Range 1 1420 is an IP address range that has been allocated to a set of hosts, e.g., a set of computers associated with a location. Fixed address 1 1422 comprises an IP address that has been allocated to a single location such as a single device.

Overlapping block 1405 comprises address block 2 1412 and address block 3 1414. Address block 2 1412 and address block 3 1414 comprise separate sets of IP addresses, wherein each IP address may be planned to be allocated to one or more hosts.

Overlapping the IP addresses (e.g., assigning fixed address 2 1426 to two different hosts) may be possible when federated realm 1402 is one of two or more federated realms. In this scenario, overlapping is allowed because different hosts with the same IP addresses may be reached through different federated realms.

Address block 2 1412 comprises subnet 2 1418 and address block 3 1414 comprises subnet 3 1419. Subnet 2 1418 and subnet 3 1419 may comprise overlapping IP address spaces as they conform to the policies of overlapping block 1405.

Subnet 2 1418 comprises range 2 1424 and fixed address 2 1426. Range 2 1424 may be allocated to two separate ranges of hosts in accordance with the overlapping IP address policies. Similarly, fixed address 2 1426 may be allocated to one or more hosts in accordance with the overlapping polices. Range 3 1428 and fixed address 3 1430 are similar to range 2 1424 and fixed address 2 1426, respectively.

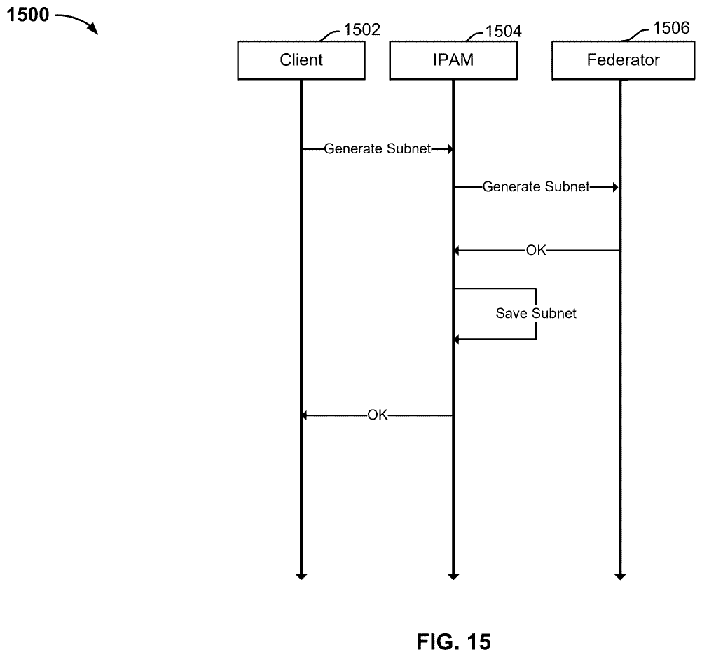

FIG. 15 is a sequence diagram for creating a subnet in a federated IPAM system in accordance with some embodiments. Sequence 1500 occurs when IPAM 1504 is associated with the same federated IPAM system as federator 1506. Client 1502 may be an IPAM manager or a user. In some embodiments, client 1502 executes this process automatically. In some embodiments, client 1502 is directed by a human. Federator 1506 may comprise a federation service. Federator 1506 is associated with a federated IPAM system. In some embodiments, IPAM 1504 and federator 1506 interface using a policy service such as an OPA.

Client 1502 sends a request to IPAM 1504 to generate a subnet. The request may comprise an API call. In some embodiments, generating a subnet in IPAM 1504 refers to the process of dividing a larger network into smaller, more manageable sub-networks or subnets. This process may involve selecting a range of IP addresses from the overall network pool and allocating them to specific subnets based on factors such as the number of devices or hosts required in each subnet. Generating a subnet may be done to enhance network efficiency, improve security, and optimize address allocation by isolating traffic within specific segments. In some embodiments, generating a subnet includes defining a subnet mask, assigning IP address ranges, and maintaining a record of subnet details such as their network address, broadcast address, and the range of valid host IPs. IPAM 1504 may streamline the management of these subnets by offering centralized control, automation of address assignments, and tracking to avoid conflicts or overlap, ensuring effective use of the IP address space.

In some embodiments, the subnet is saved (e.g., written into a database) after IPAM 1504 interfaces with federator 1506 and receives confirmation that the subnet may be generated in the federated IPAM system associated with federator 1506.

IPAM 1504 sends a request to federator 1506 to generate the subnet. Federator 1506 may validate that the set of IP addresses are associated with the subnet and allocate the subnet in the federated IPAM system. Validation comprises ensuring that the allocation is done in a manner which conforms with the policies associated with the federated IPAM system. For example, federator 1506 may validate that a subnet of a policy block may be created and delegated to the subnet of the IPAM.

In response to a determination that federator 1506 can generate the subnet, the subnet is generated in the federated IPAM system and an OK response is sent to the IPAM. Generating the subnet in the federated IPAM system may comprise saving the associated IP address range in a database and delegating the subnet range to the subnet of IPAM 1504.

In response to a reception of an OK response from the federator, IPAM 1504 saves the subnet. Saving the subnet may comprise generating a record of the subnet and the allocation in a database associated with the IPAM. For example, the subnet may be transferred from random access memory (RAM) to solid state memory.

After the subnet is generated in the IPAM, the IPAM sends an OK response to client 1502. In some embodiments, client 1502 continues an automated process, such as allocating another subnet.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
generate a federated realm to manage one or more Internet Protocol Address Management (IPAM) services;
generate a plurality of objects associated with the federated realm; and
apply policies of the plurality of objects associated with the federated realm to Internet Protocol (IP) address spaces of the one or more IPAM services; and
a memory coupled to the processor and configured to provide the processor with instructions.

2. The system of claim 1, wherein a single root authority is established for the one or more IPAM services.

3. The system of claim 1, wherein the plurality of objects associated with the federated realm includes one or more delegations.

4. The system of claim 1, wherein the plurality of objects associated with the federated realm includes one or more policy blocks.

5. The system of claim 1, wherein the one or more IPAM services include a policy service.

6. The system of claim 1, wherein the one or more IPAM services includes a policy service, wherein the policy service includes an Open Policy Agent (OPA).

7. The system of claim 1, wherein the one or more IPAM services includes an on premises (on-prem) IPAM system.

8. The system of claim 1, wherein the one or more IPAM services includes a hosted IPAM service using a cloud service provider (CSP).

9. A method, comprising:
generating a federated realm to manage one or more IPAM services;
generating a plurality of objects associated with the federated realm; and
applying policies of the plurality of objects associated with the federated realm to IP address spaces of the one or more IPAM services.

10. The method of claim 9, wherein a single root authority is established for the one or more IPAM services.

11. The method of claim 9, wherein the plurality of objects associated with the federated realm includes one or more delegations.

12. The method of claim 9, wherein the plurality of objects associated with the federated realm includes one or more policy blocks.

13. The method of claim 9, wherein the one or more IPAM services include a policy service.

14. The method of claim 9, wherein the one or more IPAM services includes a policy service, wherein the policy service includes an Open Policy Agent (OPA).

15. The method of claim 9, wherein the one or more IPAM services includes an on premises (on-prem) IPAM system.

16. The method of claim 9, wherein the one or more IPAM services includes a hosted IPAM service using a cloud service provider (CSP).

17. A computer program product embodied in a non-transitory computer readable medium and comprising computer instructions for:
generating a federated realm to manage one or more IPAM services;
generating a plurality of objects associated with the federated realm; and
applying policies of the plurality of objects associated with the federated realm to IP address spaces of the one or more IPAM services.

18. The computer program product of claim 17, wherein a single root authority is established for the one or more IPAM services.

19. The computer program product of claim 17, wherein the plurality of objects associated with the federated realm includes one or more policy blocks.

20. The computer program product of claim 17, wherein the plurality of objects associated with the federated realm includes one or more delegations.
